(19) United States
(12) Patent Application Publication
(10) Pub. No.: US 2025/0328141 A1
(43) Pub. Date: Oct. 23, 2025

(54) CONTROL METHOD FOR ROBOT, COMPUTER DEVICE, AND STORAGE MEDIUM

(71) Applicant: TENCENT TECHNOLOGY (SHENZHEN) COMPANY LIMITED, Shenzhen (CN)

(72) Inventors: Qinqin ZHOU, Shenzhen (CN); Haitao WANG, Shenzhen (CN); Shuai WANG, Shenzhen (CN); Wanchao CHI, Shenzhen (CN); Yu ZHENG, Shenzhen (CN); Xiong LI, Shenzhen (CN)

(21) Appl. No.: 19/254,282

(22) Filed: Jun. 30, 2025

Related U.S. Application Data
(63) Continuation of application No. PCT/CN2023/131610, filed on Nov. 14, 2023.

(30) Foreign Application Priority Data
May 17, 2023 (CN) 202310558206.5

(51) Int. Cl. G05D 1/241; B62D 57/02

(52) U.S. Cl. CPC G05D 1/241; B62D 57/022

(57) ABSTRACT

A control method for a robot includes obtaining a desired operation space task of the robot on a support plane, the desired operation space task including a desired acceleration of a part of the robot in an operation space of the robot, and the desired operation space task being configured for guiding the robot to alternately swing a first robotic leg set and a second robotic leg set to move on the support plane; obtaining, according to the desired operation space task and a whole-body dynamics model of the robot, a desired joint torque set corresponding to the desired operation space task, the desired joint torque set including desired joint torques configured for controlling all parts of the robot; and controlling, based on the desired joint torque set, the robot to move under guidance of the desired operation space task.

### CROSS-REFERENCES TO RELATED APPLICATIONS

This application is a continuation application of PCT Patent Application No. PCT/CN2023/131610, filed on Nov. 14, 2023, which claims priority to Chinese Patent Application No. 202310558206.5, filed on May 17, 2023, all of which is incorporated herein by reference in their entirety.

### FIELD OF THE TECHNOLOGY

Embodiments of the present disclosure relate to the field of artificial intelligence (AI) technologies, and in particular, to a control method and apparatus for a robot, a device, and a storage medium.

### BACKGROUND OF THE DISCLOSURE

As robot control technologies advances, wheel-legged robots having wheels as feet can not only slide quickly on the wheels, but also climb stairs and overcome obstacles.

Taking a wheel-legged robot climbing stairs as an example, a heuristic method is often used to control the wheel-legged robot by planning the positions of the wheel-legged robot's mechanical legs on the stairs and controlling the projection of the wheel-legged robot's center of gravity to move slowly within its support area or stance area to achieve stair climbing. This type of method is used for static stairs climbing, that is, the projection of the center of gravity of the robot does not exceed the stance area of the robot, which results in low efficiency of the robot in climbing stairs.

### SUMMARY

One embodiment of the present disclosure provides a control method for a robot, performed by a computer device, the robot including a body, and a first robotic leg set and a second robotic leg set connected to the body through hip joints, at least one of the first robotic leg set and the second robotic leg set including at least two robotic legs, and a rotation center of a hip joint corresponding to the first robotic leg set and a rotation center of a hip joint corresponding to the second robotic leg set being located on a same vertical plane. The method includes obtaining a desired operation space task of the robot on a support plane, the desired operation space task including a desired acceleration of a part of the robot in an operation space of the robot, and the desired operation space task being configured for guiding the robot to alternately swing the first robotic leg set and the second robotic leg set to move on the support plane; obtaining, according to the desired operation space task and a whole-body dynamics model of the robot, a desired joint torque set corresponding to the desired operation space task, the desired joint torque set including desired joint torques configured for controlling all parts of the robot; and controlling, based on the desired joint torque set, the robot to move under guidance of the desired operation space task.

Another embodiment of the present disclosure provides a computer device including one or more processors and a memory containing a computer program that, when being executed, causes the one or more processors to perform: obtaining a desired operation space task of the robot on a support plane, the desired operation space task including a desired acceleration of a part of the robot in an operation space of the robot, and the desired operation space task being configured for guiding the robot to alternately swing the first robotic leg set and the second robotic leg set to move on the support plane; obtaining, according to the desired operation space task and a whole-body dynamics model of the robot, a desired joint torque set corresponding to the desired operation space task, the desired joint torque set including desired joint torques configured for controlling all parts of the robot; and controlling, based on the desired joint torque set, the robot to move under guidance of the desired operation space task.

Another embodiment of the present disclosure provides a non-transitory computer readable storage medium containing a computer program that, when being executed, causes at least one processor to perform: obtaining a desired operation space task of the robot on a support plane, the desired operation space task including a desired acceleration of a part of the robot in an operation space of the robot, and the desired operation space task being configured for guiding the robot to alternately swing the first robotic leg set and the second robotic leg set to move on the support plane; obtaining, according to the desired operation space task and a whole-body dynamics model of the robot, a desired joint torque set corresponding to the desired operation space task, the desired joint torque set including desired joint torques configured for controlling all parts of the robot; and controlling, based on the desired joint torque set, the robot to move under guidance of the desired operation space task.

### BRIEF DESCRIPTION OF THE DRAWINGS

FIG. 1 is a schematic diagram of an implementation environment of a solution according to an embodiment of the present disclosure.

FIG. 2 is a schematic diagram of a quadruped wheel-legged robot according to an embodiment of the present disclosure.

FIG. 3 is a schematic diagram of a wheel-legged robot climbing stairs according to an embodiment of the present disclosure.

FIG. 4 is a schematic diagram of a wheel-legged robot crossing a road shoulder according to an embodiment of the present disclosure.

FIG. 5 is a schematic diagram of a wheel-legged robot crossing a pit according to an embodiment of the present disclosure.

FIG. 6 is a schematic diagram of a control method for a robot according to an embodiment of the present disclosure.

FIG. 7 is a flowchart of a method for obtaining a desired operation space task according to an embodiment of the present disclosure.

FIG. 8 is a schematic diagram of an inverted pendulum model of a wheel-legged robot according to an embodiment of the present disclosure.

FIG. 9 is a flowchart of a method for obtaining a desired joint torque set according to an embodiment of the present disclosure.

FIG. 10 to FIG. 12 are schematic diagrams illustrating that a quadruped wheel-legged robot climbs stairs.

FIG. 13 is a block diagram of a control apparatus for a robot according to an embodiment of the present disclosure.

FIG. 14 is a block diagram of another control apparatus for a robot according to an embodiment of the present disclosure.

FIG. 15 is a simplified structural block diagram of a computer device according to an embodiment of the present disclosure.

### DESCRIPTION OF EMBODIMENTS

To make objectives, technical solutions, and advantages of the present disclosure clearer, implementations of the present disclosure are further described in detail below with reference to drawings.

Artificial intelligence (AI) is a theory, a method, a technology, and an application system that use a digital computer or a machine controlled by the digital computer to simulate, extend, and expand human intelligence, so as to sense an environment, obtain knowledge, and obtain an optimal result with knowledge. In other words, AI is a comprehensive technology in computer science and attempts to understand the essence of intelligence and produce a new intelligent machine that can react in a manner similar to human intelligence. AI is to study the design principles and implementation methods of various intelligent machines, to enable the machines to have the functions of perception, reasoning, and decision-making.

The AI technology is a comprehensive discipline, and involves a wide range of fields including both hardware-level technologies and software-level technologies. Basic AI technologies generally include technologies such as a sensor, a dedicated AI chip, cloud computing, distributed storage, a big data processing technology, an operating/interaction system, and electromechanical integration. AI software technologies mainly include major directions such as a computer vision (CV) technology, a speech processing technology, a natural language processing technology, and machine learning/deep learning.

Technical solutions of the present disclosure mainly relate to a robot technology in the artificial intelligence technology, and mainly relate to intelligent robot control. A robot is a mechanical electronic device that is formed through combination of mechanical transmission and modern microelectronic technologies and can imitate a skill of a human, which is developed based on electronic, mechanical, and information technologies. A robot does not necessarily look like a person, and is a member of a large robot family provided that the robot can autonomously complete tasks and commands assigned to the robot by a human. A robot is an automated machine which has some intelligent capabilities, such as a perception capability, a planning capability, an action capability, and a collaborative capability, similar to those of a person or a living creature, and is an automated machine with high flexibility. As computer technologies and artificial intelligence technologies develop, robots are significantly improved in function and technologies. Technologies such as mobile robots and robot vision and touch are typical representatives.

In the technical solutions provided in the embodiments of the present disclosure, each operation may be performed by a computer device. The computer device is an electronic device having data computing, processing, and storage capabilities.

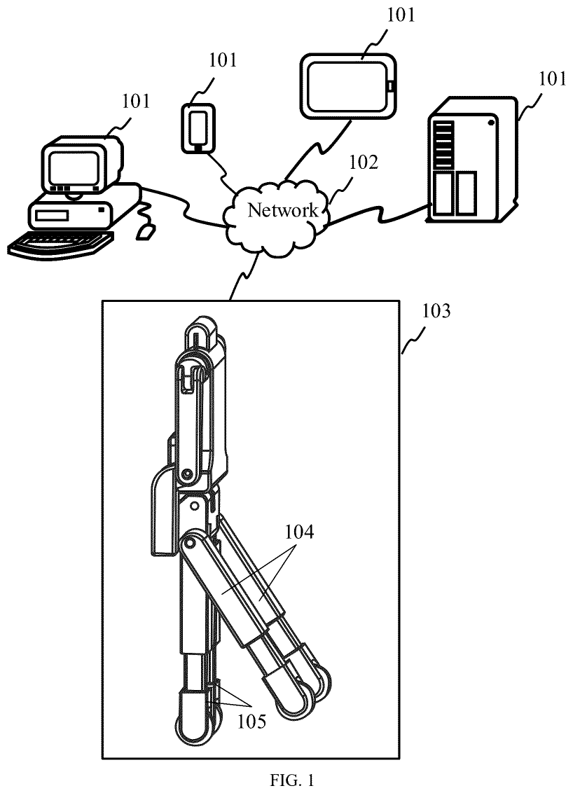

In some embodiments, the computer device may be a personal computer (PC) device configured to control robots, such as a desktop computer or a laptop computer, or may be a server configured to control a robot. The server may be an independent physical server, or may be a server cluster or a distributed system composed of a plurality of physical servers, or may be a cloud server providing a cloud computing service. The computer device and the robot may be connected by using a physical line, a network, or the like. For example, referring to FIG. 1, a computer device 101 may calculate a desired joint torque set corresponding to the robot 103 based on a desired operation space task of the robot 103 (the desired operation space task includes a desired acceleration of each part of the robot 103 in an operation space of the robot 103), and control the robot 103 to move based on the desired joint torque set through a network 102. For example, the computer device 101 may control, based on the desired joint torque set corresponding to the desired operation space task of the robot 103, a first robotic leg set 104 and a second robotic leg set 105 of the robot 103 to swing alternately, so that the robot 103 moves on a support plane.

In some embodiments, the computer device may be a robot. In other words, steps in the technical solutions provided in the embodiments of the present disclosure are performed by a robot. For example, referring to FIG. 1, the computer device 101 may transmit the desired operation space task of the robot 103 to the robot 103 through the network 102, and the robot 103 calculates the corresponding desired joint torque set based on the desired operation space task, and then moves based on the desired joint torque set. In some embodiments, the robot 103 may further automatically plan a desired operation space task based on a real environment, to execute different tasks in the real environment. This is not limited in this embodiment of the present disclosure.

The robot in the embodiments of the present disclosure may be a wheel-legged robot, a legged robot, or the like. The wheel-legged robot is a robot having a wheel as a foot portion, and the legged robot is a robot having a foot as a foot portion. This is not limited in the embodiments of the present disclosure.

In some embodiments, the robot may include a body, and a first robotic leg set and a second robotic leg set connected to the body through hip joints. At least one of the first robotic leg set and the second robotic leg set includes at least two robotic legs. For example, the first robotic leg set includes at least two robotic legs, and the second robotic leg set may also include at least two robotic legs. At least two robotic legs of the first robotic leg set are respectively located on two sides of a central axis (that is, a sagittal plane) of the robot. At least two robotic legs of the second robotic leg set are respectively located on the two sides of the central axis of the robot. The first robotic leg set and the second robotic leg set are distributed side by side. In other words, a rotation center of a hip joint corresponding to the first robotic leg set and a rotation center of a hip joint corresponding to the second robotic leg set are located on a same vertical plane.

The robot in the embodiments of the present disclosure is described by using the wheel-legged robot as an example.

The wheel-legged robot in the embodiments of the present disclosure may include a body, and an outer robotic leg set (i.e., the first robotic leg set) and an inner robotic leg set (i.e., the second robotic leg set) connected to the body through hip joints. The outer robotic leg set may include two outer robotic legs, and the inner robotic leg set may include at least one inner robotic leg. Exemplarily, the wheel-legged robot is a quadruped wheel-legged robot. In other words, the wheel-legged robot includes two outer robotic legs and two inner robotic legs. The wheel-legged robot may alternatively be a tripedal wheel-legged robot. In other words, the wheel-legged robot includes two outer robotic legs and one inner robotic leg. A hip joint corresponding to at least one inner robotic leg in the inner robotic leg set is located between hip joints corresponding to two outer robotic legs in the outer robotic leg set, and centers of rotation of the hip joints corresponding to the outer robotic legs and centers of rotation of the hip joints corresponding to the inner robotic legs are located on a same vertical plane. The wheel-legged robot can stand on the support plane through the outer robotic legs or the inner robotic legs, slide on the support plane through foot wheels on the outer robotic legs or the inner robotic legs, or move (i.e., walk) on the support plane by controlling the outer robotic leg set and the inner robotic leg set to swing alternately.

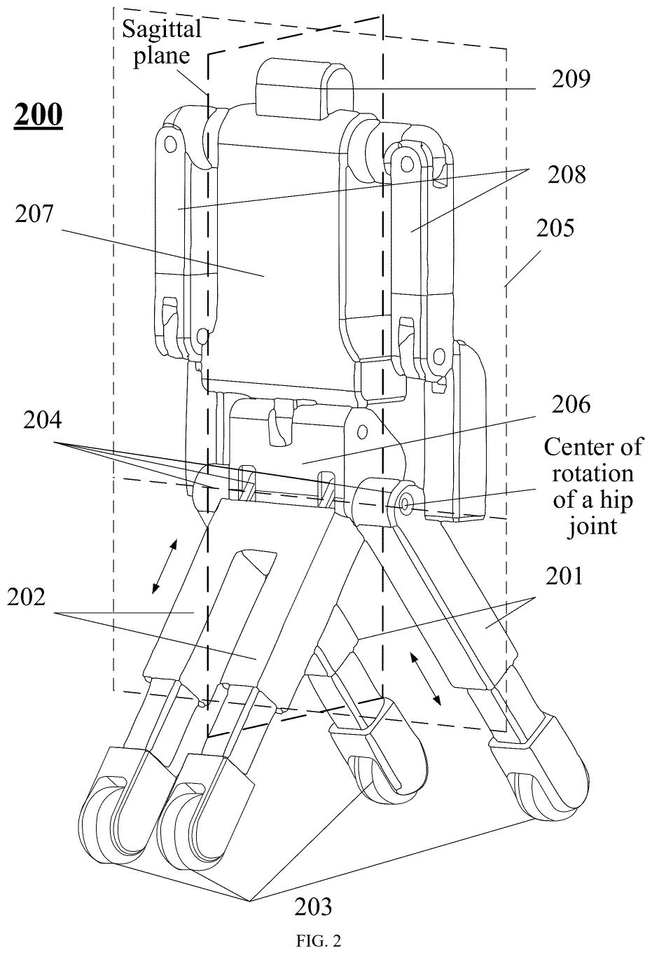

Exemplarily, FIG. 2 illustrates a schematic structural diagram of a quadruped wheel-legged robot. A quadruped wheel-legged robot 200 may include a body, a hip joint, and a robotic leg.

The quadruped wheel-legged robot 200 has four robotic legs, i.e., two outer robotic legs 201 (i.e., a first robotic leg set) and two inner robotic legs 202 (i.e., a second robotic leg set). The two inner robotic legs 202 are located between the two outer robotic legs 201, and the four robotic legs each can stretch/contract in a direction shown in the figure alone. A foot wheel 203 is mounted to an end of each of the four robotic legs, and each foot wheel 203 may be independently driven. The quadruped wheel-legged robot 200 may stand through two inner robotic legs 202 or two outer robotic legs 201, so as to be in a two-feet stance state. The quadruped wheel-legged robot 200 may stand through the two inner robotic legs 202 and the two outer robotic legs 201, so as to be in a four-feet stance state. This is not limited in the embodiments of the present disclosure.

In some embodiments, the two inner robotic legs 202 may be implemented as a whole. In other words, the quadruped wheel-legged robot 200 may be implemented as a tripedal wheel-legged robot, which has only one inner robotic leg.

Other ends of the four robotic legs are respectively connected to a hip joint 204, and the robotic legs may rotate about the respective hip joints 204 and remain in linkage. In the embodiments of the present disclosure, centers of rotation of the hip joints 204 corresponding to the quadruped wheel-legged robot 200 are located on a same vertical plane 205, and planes of rotation of the robotic legs corresponding to the quadruped wheel-legged robot 200 are parallel. The hip joints 204 corresponding to the two inner robotic legs 202 are located between the hip joints 204 corresponding to the two outer robotic legs 201.

In some embodiments, the hip joints 204 corresponding to the quadruped wheel-legged robot 200 may be coaxial, that is, the centers of rotation of the hip joints 204 are located on a same straight line. The hip joints 204 corresponding to the quadruped wheel-legged robot 200 may alternatively be non-coaxial. For example, the hip joints 204 corresponding to the two inner robotic legs 202 are coaxial, and the hip joints 204 corresponding to the two outer robotic legs 201 are coaxial, but the hip joints 204 corresponding to the two inner robotic legs 202 and the hip joints 204 corresponding to the two outer robotic legs 201 are non-coaxial.

In some embodiments, the hip joints 204 corresponding to the two outer robotic legs 201 share a driving motor, so that the two outer robotic legs 201 move synchronously. The hip joints 204 corresponding to the two inner robotic legs 202 share a driving motor, so that the two inner robotic legs 202 move synchronously. In a feasible example, each hip joint 204 corresponding to the quadruped wheel-legged robot 200 may alternatively be independently driven by a corresponding driving motor. This is not limited in the embodiments of the present disclosure.

The body of the quadruped wheel-legged robot 200 may include a waist 206, a torso 207, a head 208, and an upper leg 209.

The hip joints 204 corresponding to the quadruped wheel-legged robot 200 are connected to one same end of the waist 206, and an other end of the waist 206 are connected to one end of the torso 207. The waist 206 has two centers of rotation, i.e., a pitching rotation center that enables the torso 207 to implement pitching and a sideway swinging rotation center that enables the torso 207 to implement sideway swinging. The sideway swinging rotation center is maintained in a series design with the pitching rotation center, is located above the pitching rotation center, and is connected to the torso 207.

An other end of the torso 207 is connected to the head 208 and the upper limb 209, and the upper limb 209 may be an upper limb with a plurality of degrees of freedom. In some embodiments, an end actuator, such as a robotic claw or a sucker, is arranged on an upper part of the upper arm 209. A data collection device, such as an image capture device, a video recording device, or an inertial measurement unit (IMU) may be arranged in the head 208 to sense a real environment. The IMU may be arranged at a geometric center of the body 207, a hip joint center point (that is, a rotation center of the hip joint), or the like, and may be configured to measure an actual acceleration, an actual posture angular velocity, an actual Euler angle, or the like of the body 207.

In the technical solution provided in the embodiments of the present disclosure, the foot wheels, the robotic legs, the hip joints, the waist, and the torso (including the IMU) of the quadruped wheel-legged robot 200 are necessary hardware for a control algorithm, and the other components are unnecessary hardware.

The quadruped wheel-legged robot has a more stable structure and a stronger capability of withstanding external impact and disturbance compared with a biped wheel-legged robot, and has fewer redundant joints and lower design complexity compared with a hexapod wheel-legged robot. In addition, the quadruped wheel-legged robot can bear a large load, pass through a narrow space, and execute tasks for objects at different heights, which has a strong capability of adapting to an environment.

The control method for a robot provided in the embodiments of the present disclosure is applicable to a plurality of scenarios, such as a robot climbing stairs, a robot crossing a doorsill, a robot crossing a road shoulder, a robot crossing a pit, and any scenario of crossing an obstacle. A robot using the technical solution provided in the embodiments of the present disclosure has a stronger capability of adapting to an environment. The control method for a robot provided in the embodiments of the present disclosure can improve robot movement efficiency and robot control accuracy.

An application scenario of the technical solutions provided in the embodiments of the present disclosure is illustrated by using a wheel-legged robot as an example.

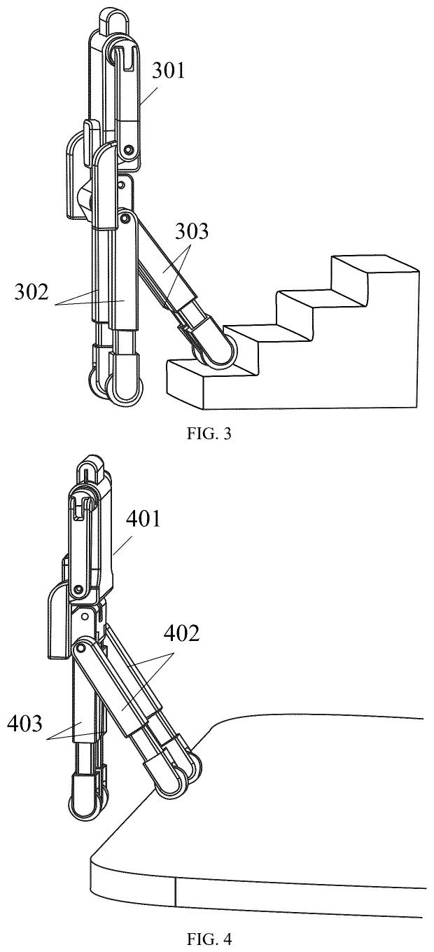

In some embodiments, referring to FIG. 3, when a wheel-legged robot 301 needs to climb stairs, the wheel-legged robot may first plan a desired operation space task based on the stairs, then calculate a desired joint torque set corresponding to the desired operation space task, and then control an outer robotic leg set 302 (i.e., a first robotic leg set) and an inner robotic leg set 303 (i.e., a second robotic leg set) to swing alternately based on the desired joint torque set, to complete stairs climbing. For example, first, the outer robotic leg set 302 is used as a stance robotic leg set and the inner robotic leg set 303 is used as a swinging robotic leg set to cause the robot 301 to climb up a first step. Then the inner robotic leg set 303 is used as a stance robotic leg set and the outer robotic leg set 302 is used as a swinging robotic leg set to cause the robot 301 to climb up a second step. The outer robotic leg set 302 and the inner robotic leg set 303 swing alternately in sequence, to complete the stairs climbing task.

In some embodiments, referring to FIG. 4, when a wheel-legged robot 401 needs to cross a road shoulder, the wheel-legged robot may first plan a desired operation space task based on the road shoulder, then calculate a desired joint torque set corresponding to the desired operation space task, and then control an outer robotic leg set 402 and an inner robotic leg set 403 to swing alternately based on the desired joint torque set, to complete the road shoulder crossing. For example, first, the inner robotic leg set 403 is used as a stance robotic leg set and the outer robotic leg set 402 is used as a swinging robotic leg set to cause the outer robotic leg set 402 of the robot 401 to climb up the road shoulder. Then the outer robotic leg set 402 is used as a stance robotic leg set and the inner robotic leg set 403 is used as a swinging robotic leg set to cause the whole robot 401 to cross the road shoulder. The inner robotic leg set 403 and the outer robotic leg set 402 swing alternately in sequence, to complete the road shoulder crossing task.

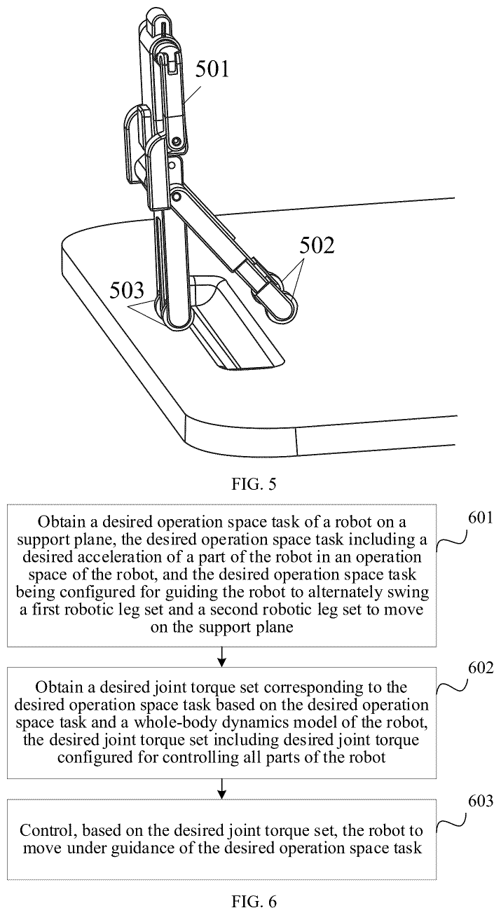

In some embodiments, referring to FIG. 5, when a wheel-legged robot 501 needs to cross a pit, the wheel-legged robot may first plan a desired operation space task based on the pit, then calculate a desired joint torque set corresponding to the desired operation space task, and then control an outer robotic leg set 502 and an inner robotic leg set 503 to swing alternately based on the desired joint torque set, to complete the pit crossing. For example, first, the inner robotic leg set 503 is used as a stance robotic leg set and the outer robotic leg set 502 is used as a swinging robotic leg set to cause the outer robotic leg set 502 of the robot 501 to cross the pit. Then the outer robotic leg set 502 is used as a stance robotic leg set and the inner robotic leg set 503 is used as a swinging robotic leg set to cause the whole robot 501 to cross the pit. The inner robotic leg set 503 and the outer robotic leg set 502 swing alternately in sequence, to complete the pit crossing task.

The control method for a robot provided in the embodiments of the present disclosure are described below through method embodiments.

FIG. 6 is a flowchart of a control method for a robot according to an embodiment of the present disclosure. In this embodiment of the present disclosure, the control method for a robot is described by using an example in which each step is performed by a robot. The method may include at least one of the following operations (601-603).

Operation 601: Obtain a desired operation space task of the robot on a support plane, the desired operation space task including a desired acceleration of each part of the robot in an operation space of the robot, and the desired operation space task being configured for guiding the robot to alternately swing the first robotic leg set and the second robotic leg set to move on the support plane.

The desired operation space task is a task of the robot in an operation space, and may be planned based on the robot and a real environment in which the robot is located. For example, desired movement of the robot on a support plane may be planned to obtain a desired operation space task corresponding to the scenario.

The robot may control each part of the robot to move through the desired acceleration in the desired operation space task, to implement movement of the robot on the support plane. For example, the robot alternately swings the first robotic leg set and the second robotic leg set, to move on the support plane in a walking form. The robot in this embodiment of the present disclosure is the same as that in the foregoing embodiment, which is not described in detail herein.

The desired acceleration is an acceleration obtained in combination with a real environment for actually controlling the robot, and the following reference acceleration is a planned value, which is an acceleration configured for guiding the robot. The robot follows the desired acceleration, so that an action corresponding to the desired acceleration can be implemented. For example, a desired acceleration corresponding to a robotic leg is configured for guiding the robotic leg to swing. In this case, the robot controls the robotic leg to follow the desired acceleration, so that swing of the robotic leg can be implemented.

In some embodiments, the desired operation space task includes a desired acceleration of each part of the robot at each control time, so that the whole robot moves based on a planned movement trajectory. The control time is a time for controlling the robot through a control signal. The control times are arranged based on a specified time interval. The specified time interval may be set and adjusted based on an actual use requirement.

In this embodiment of the present disclosure, the foregoing support plane may include only one plane, such as a flat ground or a road, or may include a plurality of planes at different heights, such as stairs, a road surface with a road shoulder, and a ground with a pit. This is not limited in this embodiment of the present disclosure. The desired acceleration in the desired operation space task may be configured for guiding the robot to alternately swing the first robotic leg set and the second robotic leg set, to perform tasks such as walking, stairs climbing, road shoulder crossing, and pit crossing.

The foregoing operation space of the robot is a Cartesian space corresponding to the robot. In task-oriented whole body control of the robot, the Cartesian space corresponding to the robot may be referred to as the operation space of the robot. In this embodiment of the present disclosure, each position in the operation space of the robot may be represented based on a world coordinate system of the robot.

For example, a world coordinate system of the robot may be constructed through a contact point between a foot of the robot in an initial state and the support plane as an origin, a horizontal direction as an x-axis direction, a vertical direction as a z-axis direction, and a direction perpendicular to both the horizontal direction and the vertical direction as a y-axis direction. A position of the robot in the operation space may be represented based on three-dimensional coordinates of the robot in the world coordinate system. In some embodiments, calculation processes in this embodiment of the present disclosure all occur in the world coordinate system of the robot.

In some embodiments, the parts may include a first robotic leg set, a second robotic leg set, and a body of the robot, and the desired operation space task includes desired accelerations respectively corresponding to the first robotic leg set, the second robotic leg set, and the body.

In some embodiments, during movement of the robot, a robotic leg set configured to swing is a swinging robotic leg set, and a robotic leg set configured for stance is a stance robotic leg set. Exemplarily, if the second robotic leg set is swung in a forward-moving direction of the robot by using the first robotic leg set as a support, the first robotic leg set is a stance robotic leg set, and the second robotic leg set is a swinging robotic leg set. If the first robotic leg set is swung in the forward-moving direction of the robot by using the second robotic leg set as a support, the second robotic leg set is a stance robotic leg set, and the first robotic leg set is a swinging robotic leg set.

A stance robotic leg set and a swinging robotic leg set corresponding to each step taken by the robot may be determined from the first robotic leg set and the second robotic leg set based on gait information of the robot. The gait information may be configured for indicating whether a robotic leg of the robot is a swinging robotic leg in each stepping period. The gait information may be planned in real time or preset. This is not limited in the present disclosure in real time. The stepping period is configured for indicating a duration for the first robotic leg set or the second robotic leg set to complete one swing.

For example, referring to FIG. 3, during stairs climbing of the robot 301, the first robotic leg set 302 and the second robotic leg set 303 are configured to swing alternately in sequence, and the second robotic leg set 303 and the first robotic leg set 302 are synchronously configured to perform stance alternately in sequence, so that the robot 301 completes the stairs climbing.

In some embodiments, the desired acceleration included in the desired operation space task may be calculated through a feedback controller, such as a proportional derivative (PD) feedback controller and other feedback controllers, based on a reference movement trajectory of each part of the robot and an actual state of the robot.

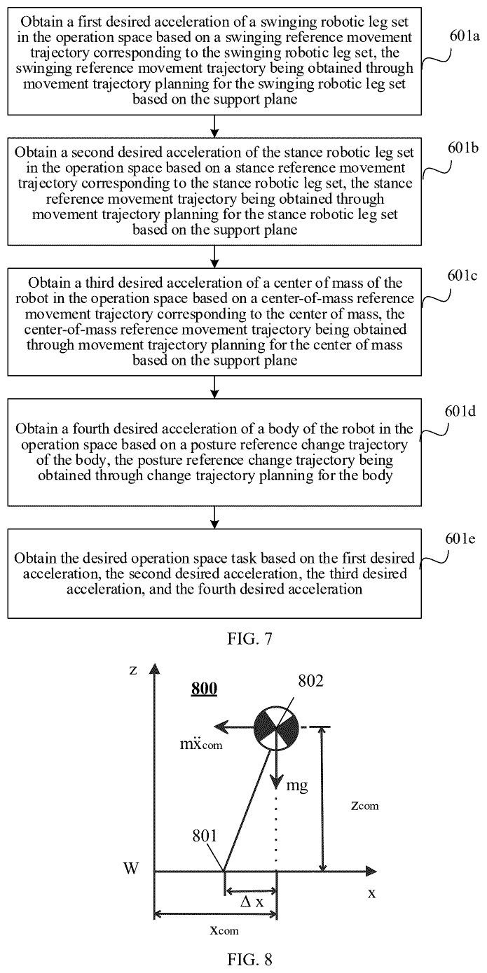

Referring to FIG. 7, the foregoing operation 601 may further include the following sub-operations:

Operation 601a: Obtain a first desired acceleration of the swinging robotic leg set in the operation space based on a swinging reference movement trajectory corresponding to the swinging robotic leg set, the swinging reference movement trajectory being obtained through movement trajectory planning for the swinging robotic leg set based on the support plane.

The swinging reference movement trajectory is a reference movement trajectory of the swinging robotic leg in the swinging robotic leg set, for example, a reference movement trajectory of a foot on the swinging robotic leg. The reference movement trajectory is configured for guiding movement of the robot. For example, the reference movement trajectory may include a reference position of the robot at each control time. The reference position is a position where the robot is desired to reach.

For example, an initial position and an end position of the swinging robotic leg in a stepping period may be planned based on size information of the support plane, then interpolation is performed on the initial position and the end position in the stepping period through a spline interpolation method, to obtain a swinging reference movement trajectory in the stepping period, and then the swinging reference movement trajectories in all stepping periods are spliced to obtain a final swinging reference movement trajectory.

Taking a quadruped wheel-legged robot climbing stairs as an example, a reference position (which is represented by three-dimensional coordinates in the world coordinate system) of a swinging robotic leg on each step of the stairs may be planned based on size information (such as a width, a height, and a length) of each step, and then interpolation may be performed between the reference positions, to obtain a swinging reference movement trajectory.

The foregoing first desired acceleration is a desired acceleration of a swinging robotic leg at each control time. For example, a desired acceleration of a foot of the swinging robotic leg at each control time may be determined as the first desired acceleration.

For example, when the robot stops moving after a plurality of control times, a process of obtaining the first desired acceleration may be as follows:

1. For each control time, a reference position, a reference velocity, and a reference acceleration of the swinging robotic leg set at the control time is obtained based on the swinging reference movement trajectory.

In some embodiments, a reference position of the swinging robotic leg set at a control time may be directly determined based on the swinging reference movement trajectory, and a reference velocity and a reference acceleration of the swinging robotic leg set at the control time may be obtained based on a reference position of the swinging robotic leg set at the control time. For example, a first-order derivation and a second-order derivation are respectively performed on the reference position of the swinging robotic leg set at the control time, to obtain the reference velocity and the reference acceleration of the swinging robotic leg set at the control time. The reference velocity is a velocity desired to be reached, and the reference acceleration is an acceleration desired to be reached, which is not directly configured for controlling the robot.

2. The first desired acceleration at the control time is calculated through a PD feedback controller based on the reference position, the reference velocity, and the reference acceleration of the swinging robotic leg set at the control time, and an actual position and an actual velocity of the swinging robotic leg set at the control time.

In some embodiments, based on the IMU on the body, an acceleration, an angular velocity, and a posture (i.e., an actual Euler angle) of the body may be measured, and then an actual position, an actual velocity, an actual posture, and an actual angular velocity of the body in the world coordinate system may be obtained through a state estimation algorithm in combination with actual angles and actual accelerations of all joints of the robot, and contact information between the robot and the support plane. If a relative position, a relative velocity, and a relative angular velocity between a hip joint center point of a hip joint and the IMU are also known, a state of the hip joint center point may be calculated based on a state of the body (i.e., an actual position, an actual velocity, an actual attitude, and an actual angular velocity of the body in the world coordinate system).

In this embodiment of the present disclosure, if the hip joint center point is a position of an origin of a floating base coordinate system of the robot, a state of the floating base coordinate system may be obtained based on the state of the hip joint center point. Then, actual positions, actual velocities, actual postures, and actual angular velocities of all links corresponding to the robot in the world coordinate system may be calculated through the forward kinematics model of the whole-body model of the robot in combination with actual angles and actual angular velocities of all joints of the robot, the links including swinging robotic legs. In this way, actual positions and actual velocities of the swinging robotic legs in the operation space can be obtained. An actual position is a real position of a swinging machine leg, which is a real value. An actual velocity is a real velocity of a swinging machine leg, which is a real value. The forward dynamics model may be configured to indicate a relationship between an acceleration of the robot in the operation space and a velocity and an acceleration of the robot in a joint space of the robot.

Exemplarily, the first desired acceleration may be represented as follows:

$${\ddot{x}}_{t , swing}^{d} = {\ddot{x}}_{t , swing}^{r} + {k}_{p , swing} ( {x}_{t , swing}^{r} - {x}_{t , swing}^{a} ) + {k}_{d , swing} ( {\dot{x}}_{t , swing}^{r} - {\dot{x}}_{t , swing}^{a} ) .$$

$${X}_{t , swing}^{r} , {\dot{X}}_{t , swing}^{r} , and {\ddot{X}}_{t , swing}^{r}$$

swing are respectively a reference position, a reference velocity, and a reference acceleration of the swinging robotic leg in the operation space at a control time t,

$${X}_{t , swing}^{a} and {\dot{X}}_{t , swing}^{a}$$

are respectively an actual position and an actual velocity of the swinging robotic leg in the operation space at the control time t, and k_{p, swing} and k_{d, swing} respectively correspond to a proportional coefficient and a differential coefficient of the swinging robotic leg.

In some examples, the robotic legs in the first robotic leg set move synchronously, and the robotic legs in the second robotic leg set move synchronously, in other words, the swinging robotic legs in the swinging robotic leg set move synchronously. If the robot has no displacement in the y-axis direction, after the y-axis direction is ignored, swinging reference movement trajectories of all of the swinging robotic legs in the swinging robotic leg set are the same. The first desired acceleration corresponding to the swinging robotic leg set may be obtained through calculation of a first desired acceleration of any swinging robotic leg. In this way, a calculation amount of the first desired acceleration can be reduced, thereby improving the robot control efficiency.

Operation 601b: Obtain a second desired acceleration of the stance robotic leg set in the operation space based on a stance reference movement trajectory corresponding to the stance robotic leg set, the stance reference movement trajectory being obtained through movement trajectory planning for the stance robotic leg set based on the support plane.

The stance reference movement trajectory is a reference movement trajectory of a stance robotic leg in the stance robotic leg set, for example, a reference movement trajectory of a foot on the stance robotic leg. The second desired acceleration includes a desired acceleration at each control time of the stance robotic leg.

In this embodiment of the present disclosure, in each stepping period, the reference position of the stance robotic leg on the support plane is a fixed value, and during stance of the stance robotic leg, no relative slide occurs between the foot of the stance robotic leg and the support plane. Therefore, a value of the second desired acceleration is constantly zero.

Exemplarily, the second desired acceleration may be represented as follows:

$${\ddot{x}}_{t , stance}^{d} = {0}_{{N}_{c} \times 1} .$$

N_{c} is a quantity of stance robotic legs (a foot of each stance robotic leg in the stance robotic leg set is in contact with the support plane, and N_{c} may alternatively be denoted as a quantity of stance contact points).

Operation 601c: Obtain a third desired acceleration of a center of mass of the robot in the operation space based on a center-of-mass reference movement trajectory corresponding to the center of mass, the center-of-mass reference movement trajectory being obtained through movement trajectory planning for the center of mass based on the support plane.

The center-of-mass reference movement trajectory is a reference movement trajectory of the center of mass of the robot. The third desired acceleration includes a reference position of the center of mass of the robot at each control time.

In some embodiments, during movement of the robot, not only the center of mass of the robot needs to continuously move in the forward-moving direction, but also the robot needs to keep dynamic balance. Therefore, a balance controller needs to be constructed to calculate a desired acceleration of the center of mass in the forward-moving direction.

For example, the center-of-mass reference movement trajectory may be divided into a reference movement sub-trajectory in the forward-moving direction and a reference movement sub-trajectory in the vertical direction, and then a third desired sub-acceleration in the forward-moving direction is determined based on the reference movement sub-trajectory in the forward-moving direction, and a third desired sub-acceleration in the vertical direction is determined based on the reference movement sub-trajectory in the vertical direction. The process may include the following content:

1. A third desired sub-acceleration of the center of mass in the first direction is obtained based on a reference movement sub-trajectory of the center-of-mass reference movement trajectory in the first direction.

The first direction may be the forward-moving direction of the robot, for example, the x-axis direction of the world coordinate system.

In some embodiments, the robot may be converted into an inverted pendulum model, to construct the balance controller.

Exemplarily, because the robot always moves in the first direction (for example, generates no displacement in the y-axis direction of the world coordinate system), the robotic legs in the stance robotic leg set move synchronously, the robotic legs in the swinging robotic leg set move synchronously, and the hip joints of the robot are coaxial, the robot may be simplified into a plane model in a sagittal plane (for example, a sagittal plane in FIG. 2).

Referring to FIG. 8, when a gravity field of the robot is uniform, a mass of the robot concentrates at a center of mass 802 of the robot. A center of a connection line between foots of two stance robotic legs is set as a virtual stance contact point 801 between the inverted pendulum model of the robot and the support plane, and the center of mass 802 and the virtual stance contact point 801 may be connected to convert a plane model of the robot into an inverted pendulum model 800 of the robot.

After the inverted pendulum model of the robot is constructed, the balance controller may be constructed based on the inverted pendulum model, and then the third desired sub-acceleration in the first direction is calculated based on the balance controller. The process may be as follows:

1). An inverted pendulum dynamics equation of the robot is constructed by using a position of the center of mass, a velocity of the center of mass, a distance between the center of mass and a stance contact point in the first direction, and a derivative of the distance as state variables and using an acceleration of the center of mass relative to the stance contact point in the first direction as a control variable, the stance contact point being a contact point between the foot corresponding to the stance robotic leg set and the support plane.

In the inverted pendulum model, the stance contact point is represented by using a virtual stance contact point. Exemplarily, the inverted pendulum dynamics equation of the robot may be expressed as follows:

$$\frac{d}{dt} [ \begin{matrix}Δ x \\ Δ \dot{x} \\ {x}_{com} \\ {\dot{x}}_{com}\end{matrix} ] = [ \begin{matrix}0 & 1 & 0 & 0 \\ 0 & 0 & 0 & 0 \\ 0 & 0 & 0 & 1 \\ g / {z}_{com} & 0 & 0 & 0\end{matrix} ] [ \begin{matrix}Δ x \\ Δ \dot{x} \\ {x}_{com} \\ {\dot{x}}_{com}\end{matrix} ] + [ \begin{matrix}0 \\ 1 \\ 0 \\ 0\end{matrix} ] Δ \ddot{x} .$$

Δx and Δx are respectively a distance between the center of mass and the stance contact point in the first direction and a derivative of the distance, x_{com} and \dot{x}_{com} are respectively the position and the velocity of the center of mass in the first direction, Δ\ddot{x} is the acceleration of the center of mass relative to the virtual stance contact point in the first direction, z_{com} is a position of the center of mass in the second direction, and g is a gravitational acceleration.

2). A feedback gain matrix of the inverted pendulum dynamics equation is calculated through a linear quadratic regulator (LQR).

The LQR is constructed based on a quadratic programming optimization method, an essence of which is to find a multi-dimensional vector under a linear constraint condition and minimize (maximize) a quadratic objective function of the multi-dimensional vector.

Exemplarily, the objective function of the inverted pendulum dynamics equation is constructed through the LQR, and then a feedback gain matrix of the inverted pendulum dynamics equation is obtained through iteration with minimizing the objective function as an objective.

3). For each control time, a reference position and a reference velocity of the center of mass and a reference distance and a reference velocity between the center of mass and the stance contact point in the first direction at the control time are obtained based on the reference movement sub-trajectory in the first direction.

In some embodiments, the reference movement sub-trajectory of the center of mass in the first direction may be obtained through planning based on the reference position of the stance robotic leg through a planning method such as a heuristic method (i.e., a trajectory is provided based on experience and a real environment) or an inverted pendulum model (a trajectory is planned through the inverted pendulum model). This is not limited in this embodiment of the present disclosure.

For example, the reference position of the center of mass in the first direction at the control time may be directly obtained based on the reference movement sub-trajectory in the first direction, and then a first-order derivation is performed on the reference position of the center of mass in the first direction at the control time to obtain the reference velocity of the center of mass in the first direction at the control time.

A reference position and a reference velocity of the stance contact point in the first direction at the control time may be obtained based on the stance reference movement trajectory, then geometric average is performed on the reference position of the stance contact point in the first direction at the control time, to obtain the reference position of the virtual stance contact point, and geometric average is performed on the reference velocity of the stance contact point in the first direction at the control time, to obtain the reference velocity of the virtual stance contact point, and then a subtraction is performed on the reference position of the virtual stance contact point in the first direction at the control time and the reference position of the center of mass in the first direction at the control time, to obtain the reference distance between the center of mass and the virtual stance contact point, and a subtraction is performed on the reference velocity of the virtual stance contact point in the first direction at the control time and the reference velocity of the center of mass in the first direction at the control time, to obtain the reference velocity between the center of mass and the virtual stance contact point.

4). A third desired sub-acceleration in the first direction at the control time is obtained based on the feedback gain matrix, the reference position and the reference velocity of the center of mass and the reference distance in the first direction at the control time, and the reference velocity between the center of mass and the stance contact point.

In some embodiments, the reference position and the reference velocity of the center of mass, and the reference distance and the reference velocity between the center of mass and the stance contact point in the first direction at the control time are used as reference values of the control variable, to obtain the control variable of the inverted pendulum dynamics equation through the LQR based on the reference values of the control variable. The process may be expressed as follows:

$$Δ \ddot{x} = K ( [ \begin{matrix}Δ {x}^{r} \\ Δ {\dot{x}}^{r} \\ {x}_{com}^{r} \\ {\dot{x}}_{com}^{r}\end{matrix} ] - [ \begin{matrix}Δ {x}^{a} \\ Δ {\dot{x}}^{a} \\ {x}_{com}^{a} \\ {\dot{x}}_{com}^{a}\end{matrix} ] ) , [ \begin{matrix}Δ {x}^{a} \\ Δ {\dot{x}}^{a} \\ {x}_{com}^{a} \\ {\dot{x}}_{com}^{a}\end{matrix} ]$$

being an actual value of a state variable.

The control variable Δ\ddot{x} of the inverted pendulum dynamics equation is the third desired sub-acceleration in the first direction, which is denoted as

$${\ddot{x}}_{t , com}^{d} .$$

The third desired sub-acceleration in the first direction obtained in this way can not only ensure following of the center-of-mass reference movement trajectory in the first direction, but also keep dynamic balance of the robot during the movement, thereby improving robot movement stability.

In some embodiments, the third desired sub-acceleration in the first direction may alternatively be calculated through the PD feedback controller based on the reference position, the reference velocity, and the reference acceleration of the center of mass in the first direction at the control time, and the actual position and the actual velocity of the center of mass in the first direction at the control time. This is not limited in this embodiment of the present disclosure.

2. A third desired sub-acceleration of the center of mass in a second direction is obtained based on a reference movement sub-trajectory of the center-of-mass reference movement trajectory in the second direction, the second direction being perpendicular to the first direction.

In some embodiments, the second direction may be a vertical direction, for example, the z-axis direction of the world coordinate system.

In this embodiment of the present disclosure, a height between the center of mass of the robot and a foot of the stance robotic leg of the robot is set to a constant value. The constant value may be a distance between the center of mass of the robot and a center of the foot corresponding to the stance robotic leg (for example, a wheel center) in the z-axis direction. Therefore, the reference movement sub-trajectory of the center of mass in the second direction may be planned based on the stance reference movement trajectory and the constant value. For example, the reference movement sub-trajectory of the center of mass in the second direction is obtained through interpolation by using a spline interpolation method based on a sum of a reference position in the stance reference movement trajectory and the constant value.

In some embodiments, the reference movement sub-trajectory in the second direction may be equivalent to a reference movement trajectory of the body of the robot in the second direction. By following the reference movement sub-trajectory in the second direction, the body can move in the vertical direction, to adjust the position of the center of mass. Particularly, in stairs climbing scenario, by following the reference movement sub-trajectory in the second direction, the robot can climb up stairs in the vertical direction.

For example, when the robot stops moving after a plurality of control times, a process of obtaining the third desired acceleration in the second direction may be as follows:

1. For each control time, a reference position, a reference velocity, and a reference acceleration of the center of mass in the second direction at the control time are obtained based on the reference movement sub-trajectory in the second direction.

In some embodiments, the reference position of the center of mass in the second direction at the control time may be directly determined based on the reference movement sub-trajectory in the second direction, and then a first-order derivation and a second-order derivation are respectively performed on the reference position of the center of mass in the second direction at the control time, to obtain the reference velocity and the reference acceleration of the center of mass in the second direction at the control time.

2. The third desired sub-acceleration in the second direction at the control time is calculated through the PD feedback controller based on the reference position, the reference velocity, and the reference acceleration of the center of mass in the second direction at the control time, and an actual position and an actual velocity of the center of mass in the second direction at the control time.

In some embodiments, based on the IMU on the body, an acceleration, an angular velocity, and a posture (i.e., an actual Euler angle) of the body may be measured, and then an actual position, an actual velocity, an actual posture, and an actual angular velocity of the body in the world coordinate system may be obtained through a state estimation algorithm in combination with actual angles and actual accelerations of all joints of the robot, and contact information between the robot and the support plane. Finally, the actual position and the actual velocity of the body in the world coordinate system are directly determined as an actual position and an actual velocity of the center of mass in the world coordinate system, to obtain the actual position and the actual velocity of the center of mass in the second direction.

Exemplarily, the third desired sub-acceleration in the second direction may be represented as follows:

$${\ddot{x}}_{t , base}^{d} = {\ddot{x}}_{t , base}^{r} + \text{?} ( \text{?} - \text{?} ) + {k}_{d , base} ( {\dot{x}}_{t , base}^{r} - \text{?} ) .$$

$${x}_{t , base}^{r} , {\dot{x}}_{t , base}^{r} , and \text{?}$$

$$\text{?} \text{indicates text missing or illegible when filed}$$

are respectively a reference position, a reference velocity, and a reference acceleration of the center of mass in the second direction at the control time t,

$${x}_{t , base}^{a} and {\dot{x}}_{t , base}^{a}$$

base are respectively an actual position and an actual velocity of the center of mass in the second direction at the control time t, and k_{p, base} and k_{d, base} respectively correspond to a proportional coefficient and a differential coefficient of the center of mass.

3. The third desired acceleration is obtained based on the third desired sub-acceleration of the center of mass in the first direction and the third desired sub-acceleration of the center of mass in the second direction.

In this embodiment of the present disclosure, during the determining of the third desired acceleration, the third desired sub-accelerations of the center of mass respectively corresponding to the first direction and the second direction are taken into comprehensive consideration, which improves accuracy of the determined third desired acceleration.

For each control time, to obtain the third desired acceleration may be obtained through combination of the third desired sub-acceleration of the center of mass in the first direction and the third desired sub-acceleration of the center of mass in the second direction.

Operation 601d: Obtain a fourth desired acceleration of a body of the robot in the operation space based on a posture reference change trajectory of the body, the posture reference change trajectory being obtained through change trajectory planning for the body.

The posture reference change trajectory is a reference change trajectory of a posture of the body of the robot, and may be configured for describing a posture change of the body of the robot. For example, the posture reference change trajectory may include a reference posture of the body of the robot at each control time. In some embodiments, the posture of the body may be represented by using a Euler angle, for example, a Euler angle formed by a roll, a pitch, and a yaw of the body. In this case, the posture reference change trajectory may be a Euler angle reference movement trajectory corresponding to the body of the robot. The Euler angle reference movement trajectory includes a reference posture angle (i.e., a reference Euler angle) at each control time.

The fourth desired acceleration includes a desired acceleration of the body of the robot at each control time. When the posture of the body is represented by using a Euler angle, the desired acceleration may be a desired posture angular acceleration (that is, a desired Euler angular acceleration).

In some embodiments, when the robot stops moving after a plurality of control times, a process of obtaining the fourth desired acceleration may be as follows:

1. For each control time, a reference posture angle, a reference posture angular velocity, and a reference posture angular acceleration of the body at the control time are obtained based on the posture reference change trajectory.

In this embodiment of the present disclosure, the body of the robot keeps vertical during movement of the robot, and a value of a reference posture angle, and a value of the reference posture angle, a value of the reference posture angular velocity, and a value of the reference posture angular acceleration corresponding to the body are all zero. For example, the value of the reference posture angle, the value of the reference posture angular velocity, and the value of the reference posture angular acceleration may be respectively represented as:

$${x}_{t , euler}^{r} = {0}_{3 \times 1} , {\dot{x}}_{t , euler}^{r} = {0}_{3 \times 1} , and {\ddot{x}}_{t , euler}^{r} = {0}_{3 \times 1} .$$

2. The fourth desired acceleration at the control time is calculated through the PD feedback controller based on the reference posture angle, the reference posture angular velocity, and the reference posture angular acceleration of the body at the control time, and an actual posture angle and an actual posture angular velocity of the body at the control time.

In some embodiments, based on the IMU on the body, an acceleration, an angular velocity, and a posture (i.e., an actual Euler angle) of the body may be measured, and then an actual position, an actual velocity, an actual posture, and an actual angular velocity of the body in the world coordinate system may be obtained through a state estimation algorithm in combination with actual angles and actual accelerations of all joints of the robot, and contact information between the robot and the support plane. Finally, the actual posture angle (i.e., an actual Euler angle) and the actual posture angular velocity (i.e., an actual Euler angular velocity) of the body may be obtained based on the actual state of the body in the world coordinate system.

Exemplarily, the fourth desired acceleration may be represented as follows:

$${\ddot{x}}_{t , euler}^{d} = {\ddot{x}}_{t , euler}^{r} + \text{?} ( {x}_{t , euler}^{r} - \text{?} ) + \text{?} ( {\dot{x}}_{t , euler}^{r} - \text{?} ) .$$

$${x}_{t , euler}^{a} and {x}_{t , euler}^{a}$$

$$\text{?} \text{indicates text missing or illegible when filed}$$

are respectively an actual posture angle and an actual posture angular velocity of the body in the operation space at the control time t, and k_{p, euler} and k_{d, euler} respectively correspond to a proportional coefficient and a differential coefficient of the posture of the body.

Operation 601e: Obtain the desired operation space task based on the first desired acceleration, the second desired acceleration, the third desired acceleration, and the fourth desired acceleration.

In this embodiment of the present disclosure, the desired operation space task is obtained through the first desired acceleration, the second desired acceleration, the third desired acceleration, and the fourth desired acceleration, which improves accuracy of the obtained desired operation space task.

In some embodiments, the desired operation space task may be expressed as follows:

$${\ddot{x}}_{t}^{d} = [ \begin{matrix}{\ddot{x}}_{t , stance}^{d} \\ {\ddot{x}}_{t , base}^{d} \\ {\ddot{x}}_{t , euler}^{d} \\ {\ddot{x}}_{t , swing}^{d} \\ {\ddot{x}}_{t , com}^{d}\end{matrix} ] .$$

Operation 602: Obtain a desired joint torque set corresponding to the desired operation space task based on the desired operation space task and a whole-body dynamics model of the robot, the desired joint torque set including desired joint torques configured for controlling all parts of the robot.

In some embodiments, the foregoing desired operation space task may be configured for task-oriented whole body control of the robot. To be specific, the robot is controlled to complete one or more set tasks by invoking all degrees of freedom of the robot in consideration of dynamics information such as masses and inertias of all links of the robot.

For example, based on rigid-body dynamics of the robot, a whole-body dynamics model of the robot in a joint space system may be expressed as follows:

$$H \ddot{q} + C = {S}^{T} τ + {J}_{c}^{T} f .$$

H∈ [symbol] ^{N}^{_{G}}^{×N}^{_{G}} represents a joint space inertial matrix of the robot, C∈ [symbol] ^{N}^{_{G}} represents a joint space offset force vector of the robot, i.e., a sum of a Coriolis force, a centrifugal force, and a gravity corresponding to the robot, S∈ [symbol] ^{N}^{_{J}}^{×N}^{_{G}} represents a selection matrix of the robot, J_{c}∈ [symbol] ^{N}^{_{c}}^{×N}^{_{G}} represents a Jacobian matrix of the contact point between the robot and the support plane, τ∈ [symbol] ^{N}^{_{J}} represents an active joint torque vector of the robot, represents a contact force vector of the robot, q, \dot{q}, \ddot{q}∈ [symbol] ^{N}^{_{G}} represent a generalized position vector, a generalized velocity vector, and a generalized acceleration vector at each degree of freedom of the robot, N_{G} represents a total degree of freedom of the robot, i.e., a sum of a floating base degree of freedom N_{F} and an active joint degree of freedom N_{J}, and N_{C} represents a quantity of contact forces corresponding to the robot, i.e., a product of quantity n_{C} of contact points and a dimension N_{D}∈{0, 1, 2, 3} of a single contact force.

Taking the quadruped wheel-legged robot in FIG. 2 as an example, links of the quadruped wheel-legged robot may include four robotic legs, four wheels, a waist in a body (which is separately used as a link root), and a body, upper limbs, and a head in the body (which are a single piece). Active joints of the quadruped wheel-legged robot may include two hip joints, linear stretching/retraction joints respectively corresponding to the four robotic legs, rotation joints of the four wheels, and one pitch rotation joint (pitch and sideway swing). In some embodiments, active joint degrees of freedom of the robot are degrees of freedom respectively corresponding to the 11 active joints.

The floating base degree of freedom includes six degrees of freedom, i.e. positions px-py-pz and postures yaw-roll-pitch of a floating base coordinate system of the robot in the world coordinate system. The floating base coordinate system is constructed by using the hip joint rotation center as an origin, and coordinate axis directions of the floating base coordinate system in an initial state are the same as those of the world coordinate system. The quantity of contact points may be a quantity of robotic legs configured for stance. For example, during swinging of the swinging robotic leg set, the quantity of contact points is two.

In some embodiments, referring to FIG. 9, operation 602 may further include the following sub-operations:

Operation 602a: Obtain a forward dynamics model of the robot, the forward dynamics model being configured to indicate a relationship between an acceleration of the robot in the operation space and a velocity and an acceleration of the robot in a joint space of the robot.

In some embodiments, it may be learned from rigid body dynamics that, the forward dynamics model of the robot may be expressed as follows:

$${\ddot{x}}_{t} = {\dot{J}}_{t} \dot{q} + {J}_{t} \ddot{q} .$$

\ddot{x}ₜ represents an acceleration of the robot in the operation space at the control time t, \dot{q} and \ddot{q} respectively represent the velocity and the acceleration of the robot in joint space, i.e., a generalized position vector and a generalized velocity vector at each degree of freedom of the robot, and Jₜ and \dot{J}ₜ represent a Jacobian matrix corresponding to the operation space and a first derivative of the Jacobian matrix.

Operation 602b: Combine the whole-body dynamics model and the forward dynamics model, to obtain a target dynamics equation, the acceleration of the robot in the joint space being used as an unknown variable of the target dynamics equation.

The whole-body dynamics model and the forward dynamics model are combined and then simplified to obtain:

$$[ \begin{matrix}H & - {S}^{T} & - {J}_{c}^{T} \\ {J}_{t} & {0}_{{N}_{τ} \times {N}_{J}} & {0}_{{N}_{τ} \times {N}_{c}}\end{matrix} ] [ \begin{matrix}\ddot{q} \\ τ \\ f\end{matrix} ] = [ \begin{matrix}- C \\ {\ddot{x}}_{t} - {\dot{J}}_{t} \dot{q}\end{matrix} ] , [ \begin{matrix}\ddot{q} \\ τ \\ f\end{matrix} ]$$

being an unknown variable, and others being known variables.

Operation 602c: Substitute the desired operation space task into the target dynamics equation, to obtain the desired joint torque set.

In some embodiments, the movement of the robot is further physically limited by a body structure of the robot and a driving motor. To improve rationality and accuracy of the desired joint torque set, in the present disclosure, a constraint is further set during obtaining of the desired joint torque set. Therefore, operation 602c may further include the following content:

1. The acceleration of the robot in the operation space in the target dynamics equation is replaced with the desired operation space task, to obtain an intermediate dynamics equation.

In some embodiments, the foregoing

$${\ddot{x}}_{t}^{d}$$

may be used to replace the acceleration \ddot{x}ₜ of the robot in the operation space in the target dynamics equation, to obtain the intermediate dynamics equation.

2. A physical joint constraint expression and a friction constraint expression of the robot are constructed, the physical joint constraint expression being configured for constraining each joint of the robot, and a contact force between the robot under a constraint of the friction constraint expression and the support plane satisfying a friction cone constraint.

In some embodiments, an active joint torque τ in the unknown variable is limited by an actual physical property of the driving motor of the robot. In other words, the physical joint constraint expression may be τ_{lb}≤τ≤τ_{ub}, τ_{lb} and τ_{ub} respectively represent a minimum value and a maximum value of a moment of the driving motor.

In some embodiments, the contact force corresponding to the foot of the robotic leg of the robot needs to satisfy the friction cone constraint. To reduce nonlinearity, a friction cone may be approximated as a friction pyramid. In this case, the friction constraint expression may be:

$$[ \begin{matrix}- {μ}_{i} {n}_{z}^{T} \pm {n}_{x}^{T} \\ - {μ}_{i} {n}_{z}^{T} \pm {n}_{y}^{T} \\ - {n}_{z}^{T} \\ {n}_{z}^{T}\end{matrix} ] {f}_{i} \leq [ \begin{matrix}0 \\ 0 \\ - {f}_{z , lb} \\ {f}_{z , ub}\end{matrix} ] .$$

nₓ, n_{y}, and n_{z} respectively represent unit orthogonal bases along a contact surface, in the world coordinate system, μᵢ represents a friction coefficient corresponding to an i^{th} contact force, fᵢ represents the i^{th} contact force, and f_{z,lb} and f_{z,ub} respectively represent a minimum value and a maximum value of a non-negative positive pressure perpendicular to the contact surface.

3. The intermediate dynamics equation is solved under constraints of the physical joint constraint expression and the friction constraint expression of the robot, to obtain the desired joint torque set.

In some embodiments, the intermediate dynamics equation may be rewritten into AX=B

$$A = [ \begin{matrix}H & - {S}^{T} & - {J}_{c}^{T} \\ {J}_{t} & {0}_{{N}_{τ} \times {N}_{J}} & {0}_{{N}_{τ} \times {N}_{c}}\end{matrix} ] , x = [ \begin{matrix}\ddot{q} \\ τ \\ f\end{matrix} ] , and$$

$$B = [ \begin{matrix}- C \\ {\ddot{x}}_{t} - {\dot{J}}_{t} \dot{q}\end{matrix} ] .$$

The solving process of AX=B is actually solving a linear equation system. Therefore, a quadratic programming optimization method may be used herein to construct an objective function of the intermediate dynamics equation.

In some embodiments, the objective function of the intermediate dynamics equation may be expressed as follows:

$$J = min ( AX - B ) {}^{T} Q ( AX - B ) + {X}^{T} RX .$$

Q and R represent weight matrices.

The desired joint torque set is obtained under an optimization objective of minimizing the objective function and under the constraints of the physical joint constraint expression and the friction constraint expression of the robot. For example, an unknown variable X may be obtained through a secondary programming optimizer under the optimization objective of minimizing the objective function and under the constraints of the physical joint constraint expression and the friction constraint expression of the robot, and an active joint torque τ in the unknown variable X may be directly determined as the desired joint torque set. The method refines a method for determining the desired joint torque set, and improves efficiency of obtaining the desired joint torque set.

Taking the quadruped wheel-legged robot in FIG. 2 as an example, the desired joint torque set may include desired joint torques respectively corresponding to the two hip joints, the linear stretching/retraction joints respectively corresponding to the four robotic legs, the rotation joints of the four wheels, and the one pitch rotation joint (pitch and sideway swing).

In some embodiments, if a model structure of a robot is relatively simple, a dynamics equation of the robot is also relatively simple. In this case, the intermediate dynamics equation may be solved directly in a matrix inversion, i.e., X=A⁻¹B, so as to obtain the desired joint torque set.

Operation 603: Control, based on the desired joint torque set, the robot to move under guidance of the desired operation space task.

The desired joint torque set includes desired joint torques of all active joints of the robot at all control times. At any control time, only a driving motor corresponding to each active joint needs to be driven based on the desired joint torque of each active joint at the control time, to implement following of the desired operation space task. To be specific, the robot may move under guidance of the desired operation space task, and follow each reference movement trajectory corresponding to the desired operation space task, to implement control of the robot.

In conclusion, in the technical solutions provided in the embodiments of the present disclosure, for a robot having a first robotic leg set and a second robotic leg set, because rotation centers of hip joints corresponding to the robot are located in a same vertical plane, a desired operation space task may be planned, so that the robot quickly moves in a dynamic balance state (that is, a center of gravity of the robot may exceed a stance area of the robot) by causing one robotic leg set to perform stance and the other robotic leg set to swing. In addition, controlling the first robotic leg set and the second robotic leg set to swing alternately to control the robot to move can further improve the robot movement efficiency.

The center of gravity of the robot is a gravity concentration point of the robot, and the center of mass of the robot is a weighted average of a particle position with respect to a mass of the robot. If a gravity is equalized, the center of mass and the center of gravity may overlap. The stance area of the robot is an area defined by contact points between a foot on each robotic leg of the robot and the support plane. In the related art, a projection of a center of gravity needs to be controlled to be always in a stance area, resulting in a very small center-of-mass velocity of the robot and slow movement of the entire robot. However, in this embodiment of the present disclosure, the center of gravity of the robot may exceed the stance area of the robot, which achieves very quick movement, thereby improving the robot movement efficiency.

In addition, an accurate desired joint torque set corresponding to the desired operation space task can be obtained through the whole-body dynamics model of the robot based on the desired operation space task, so that the desired operation space task can be accurately implemented based on the desired joint torque set, thereby improving control accuracy of the quadruped wheel-legged robot.

In addition, the intermediate dynamics equation is solved under the constraints of the physical joint constraint expression and the friction constraint expression of the robot, to obtain a proper and accurate desired joint torque set, thereby further improving the robot control accuracy.

In addition, the third desired sub-acceleration of the center of mass in the forward-moving direction is calculated through the inverted pendulum model, so that not only the center of mass of the robot can continuously move in the forward-moving direction, but also the robot can keep dynamic balance, thereby enabling the robot to move stably and rapidly, and further improving robot control stability and robot movement efficiency. Moreover, the third desired acceleration of the center of mass in the second direction is calculated through the PD feedback controller, and the fourth desired acceleration is calculated through the PD feedback controller, so that the robot is more stably controlled through the finally determined desired acceleration.

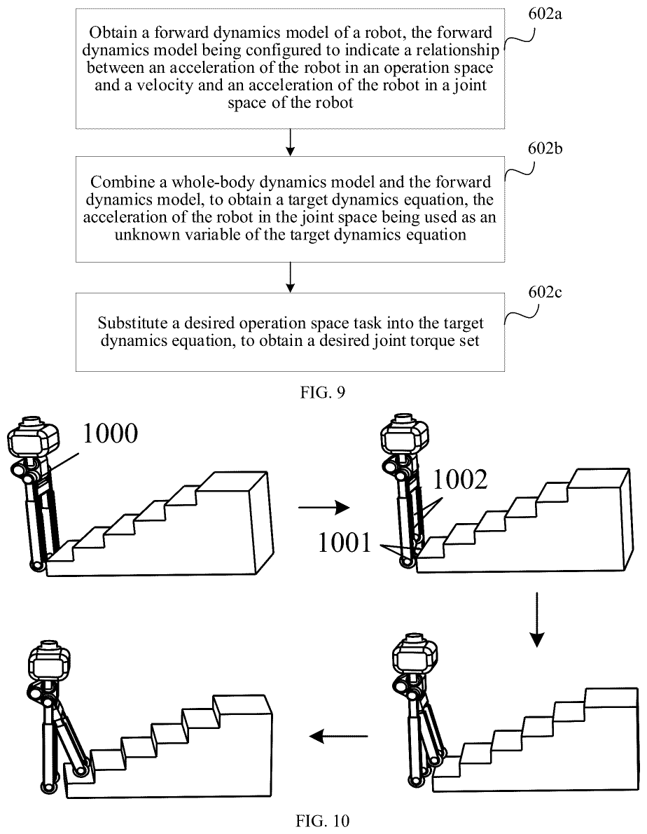

In some embodiments, referring to FIG. 10 to FIG. 12, the technical solution provided in this embodiment of the present disclosure is described by using an example in which a quadruped wheel-legged robot climbs stairs. The technical solution may include the following content:

If a quadruped wheel-legged robot 1000 climbs up a step in each stepping period, a reference position (including coordinates in the x-axis direction and the z-axis direction) of the quadruped wheel-legged robot 1000 on each step may be planned based on size information of each step and a radius of a wheel. Then, a stance movement reference trajectory of a stance robotic leg set, a swinging movement reference trajectory of a swinging robotic leg set, and a center-of-mass reference movement trajectory of the robot are planned based on the reference positions. Because the quadruped wheel-legged robot 1000 keeps vertical in the movement process, a posture change reference trajectory of the quadruped wheel-legged robot 1000 may be planned.

The quadruped wheel-legged robot 1000 adopts the technical solution provided in the foregoing embodiment. The first desired acceleration of the swinging robotic leg set at each control time is obtained based on the swinging reference movement trajectory, the second desired acceleration of the stance robotic leg set at each control time is obtained based on the stance reference movement trajectory, the third desired acceleration of the center of mass at each control time is obtained based on the center-of-mass reference movement trajectory, the fourth desired acceleration of the body at each control time is obtained based on the posture reference change trajectory, and the desired operation space task of the quadruped wheel-legged robot 1000 is obtained based on the first desired acceleration, the second desired acceleration, the third desired acceleration, and the fourth desired acceleration at each control time.

The quadruped wheel-legged robot 1000 further adopts the technical solution provided in the foregoing embodiment. The desired joint torque set corresponding to the desired operation space task is obtained, the desired joint torque set including desired joint torques of two hip joints, desired joint torques of linear stretching/retraction joints respectively corresponding to four robotic legs, desired joint torques of rotation joints of four wheels, and a desired joint torque of one pitch rotation joint at each control time.

The quadruped wheel-legged robot 1000 controls the quadruped wheel-legged robot 1000 to climb stairs based on the desired joint torque set. Specific content may be as follows:

An initial state in which the quadruped wheel-legged robot 1000 climbs the stairs is an overlapped standing state, which means that the four robotic legs of the quadruped wheel-legged robot 1000 in the initial state are synchronously closed together in a forward-moving direction (for example, a horizontal rightward direction). The initial state of the quadruped wheel-legged robot 1000 is not limited in this embodiment of the present disclosure. For example, the initial state of the robot may be a four-feet stance state or a dual-feet stance state. This is not limited in this embodiment of the present disclosure.

1. In a first stepping period (refer to FIG. 10), the quadruped wheel-legged robot 1000 swings an inner robotic leg set 1002 (i.e., a second robotic leg set) in the forward-moving direction by using an outer robotic leg set 1001 (i.e., a first robotic leg set) as a support, so that the quadruped wheel-legged robot 1000 climbs up a first step of stairs.

For two inner robotic legs in the inner robotic leg set 1002, inner hip joints corresponding to the two inner robotic legs (which are referred to as inner hip joints for short below) are controlled to rotate based on desired joint torques of the hip joints, so that the two inner robotic legs swing synchronously in the forward-moving direction, inner linear stretching/retraction joints corresponding to the two inner robotic legs (which are referred to as inner linear stretching/retraction joints for short below) are controlled to stretch/contract based on desired joint torques of the linear stretching/retraction joints, and leg lengths of the two inner robotic legs are synchronously reduced, so that the two inner robotic legs are both higher than the first step and do not contact the first step.

Then, the inner hip joints are further controlled to rotate through the desired joint torques of the inner hip joints, so that the two inner robotic legs further swing synchronously in the forward-moving direction, and the inner linear stretching/retraction joints are controlled to stretch through the desired joint torques of the inner linear stretching/retraction joints, and the leg lengths of the two inner robotic legs are synchronously increased, so that the inner robotic leg set 1002 reaches a reference position on the first step.

In the process, the quadruped wheel-legged robot 1000 controls two outer robotic legs in the outer robotic leg set 1001 to adaptively and synchronously stretch through desired joint torques of outer linear stretching/retraction joints, and causes the two outer robotic legs to perform stance through desired joint torques of outer hip joints. The quadruped wheel-legged robot 1000 controls a body to keep vertical through a desired joint torque of the pitch rotation joint.

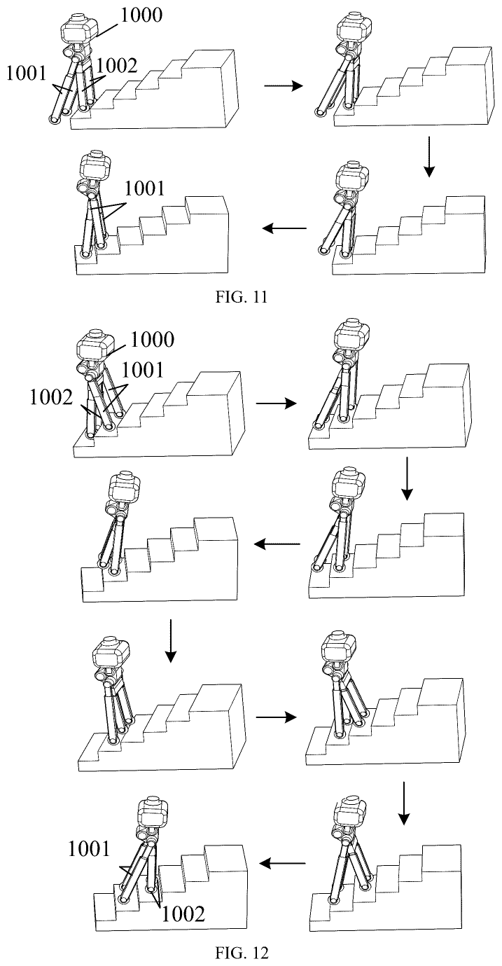

2. In a second stepping period (refer to FIG. 11), the quadruped wheel-legged robot 1000 swings the outer robotic leg set 1001 in the forward-moving direction by using the inner robotic leg set 1002 as a support, so that the quadruped wheel-legged robot 1000 climbs up a second step of the stairs.

For the two outer robotic legs in the outer robotic leg set 1001, the outer hip joints are controlled to rotate through the desired joint torques of the outer hip joints, so that the two outer robotic legs swing synchronously in the forward-moving direction, the outer linear stretching/retraction joints are controlled to contract through the desired joint torques of the outer linear stretching/retraction joints, and leg lengths of the two outer robotic legs are controlled to synchronously decrease, so that the two outer robotic legs are both higher than the first step and do not contact the first step.

Then the outer hip joints are controlled to further rotate through the desired joint torques of the outer hip joints, so that the two outer robotic legs further swing synchronously in the forward-moving direction, the outer linear stretching/retraction joints are further controlled to contract through the desired joint torques of the outer linear stretching/retraction joints, and the leg lengths of the two outer robotic legs are controlled to synchronously decrease, so that the two outer robotic legs are both higher than the second step and do not contact the second step.

Finally, the outer hip joints are further controlled to rotate through the desired joint torques of the outer hip joints, so that the two outer robotic legs further swing synchronously in the forward-moving direction, and the outer linear stretching/retraction joints are controlled to stretch through the desired joint torques of the outer linear stretching/retraction joints, and the leg lengths of the two outer robotic legs are synchronously increased, so that the outer robotic leg set 1001 reaches a reference position on the second step.

In the process, the quadruped wheel-legged robot 1000 controls the two inner robotic legs in the inner robotic leg set 1002 to adaptively and synchronously stretch through the desired joint torques of the inner linear stretching/retraction joints, and causes the two inner robotic legs to perform stance through the desired joint torques of the inner hip joints. The quadruped wheel-legged robot 1000 controls the body to keep vertical through the desired joint torque of the pitch rotation joint. The body of the quadruped wheel-legged robot 1000 vertically moves in the forward-moving directions as the two inner robotic legs are stretched, to adjust a center of mass of the quadruped wheel-legged robot 1000.

3. In a third stepping period (refer to FIG. 12), the quadruped wheel-legged robot 1000 swings the inner robotic leg set 1002 in the forward-moving direction by using the outer robotic leg set 1001 as a support, so that the quadruped wheel-legged robot 1000 climbs up a third step of the stairs.

For the two inner robotic legs in the inner robotic leg set 1002, the inner hip joints are controlled to rotate through the desired joint torques of the inner hip joints, so that the two inner robotic legs swing synchronously in the forward-moving direction, the inner linear stretching/retraction joints are controlled to contract through the desired joint torques of the inner linear stretching/retraction joints, and the leg lengths of the two inner robotic legs are controlled to synchronously decrease, so that the two inner robotic legs are both higher than the second step and do not contact the second step.

Then the inner hip joints are controlled to further rotate through the desired joint torques of the inner hip joints, so that the two inner robotic legs further swing synchronously in the forward-moving direction, the inner linear stretching/retraction joints are further controlled to contract through the desired joint torques of the inner linear stretching/retraction joints, and the leg lengths of the two inner robotic legs are controlled to synchronously decrease, so that the two inner robotic legs are both higher than the third step and do not contact the third step.

Finally, the inner hip joints are further controlled to rotate through the desired joint torques of the inner hip joints, so that the two inner robotic legs further swing synchronously in the forward-moving direction, and the inner linear stretching/retraction joints are controlled to stretch through the desired joint torques of the inner linear stretching/retraction joints, and the leg lengths of the two inner robotic legs are synchronously increased, so that the inner robotic leg set 1002 reaches a reference position on the third step.

In the process, the quadruped wheel-legged robot 1000 controls two outer robotic legs in the outer robotic leg set 1001 to adaptively and synchronously stretch through desired joint torques of the outer linear stretching/retraction joints, and causes the two outer robotic legs to perform stance through the desired joint torques of the outer hip joints. The quadruped wheel-legged robot 1000 controls the body to keep vertical through the desired joint torque of the pitch rotation joint. The body of the quadruped wheel-legged robot 1000 vertically moves in the forward-moving directions as the two outer robotic legs are stretched, to adjust the center of mass of the quadruped wheel-legged robot 1000.

In subsequent stepping periods, the inner robotic leg set 1002 and the outer robotic leg set 1001 swing interactively, so that the quadruped wheel-legged robot 1000 climbs up the stairs.

In conclusion, in the technical solution provided in this embodiment of the present disclosure, for the quadruped wheel-legged robot having the inner robotic leg set and the outer robotic leg set, because centers of rotation of the hip joints corresponding to the inner robotic leg set and the outer robotic leg set are located on a same vertical plane, one robotic leg set may be caused to stand, and the other robotic leg set may be caused to swing, so that the robot quickly climb the stairs in a dynamic balanced state (to be specific, a center of gravity of the robot may exceed a stance area of the robot), thereby improving the robot movement efficiency. In addition, controlling the inner robotic leg set and the outer robotic leg set to swing alternately to control the robot to climb the stairs can further improve stairs climbing efficiency of the robot.

In addition, an accurate desired joint torque set corresponding to the desired operation space task can be obtained through the whole-body dynamics model of the robot based on the desired operation space task, so that the desired operation space task can be accurately implemented based on the desired joint torque set, thereby improving robot control accuracy.

An apparatus embodiment of the present disclosure is described below, which may be configured for performing the method embodiment of the present disclosure. For details not disclosed in the apparatus embodiment of the present disclosure, refer to the method embodiment of the present disclosure.

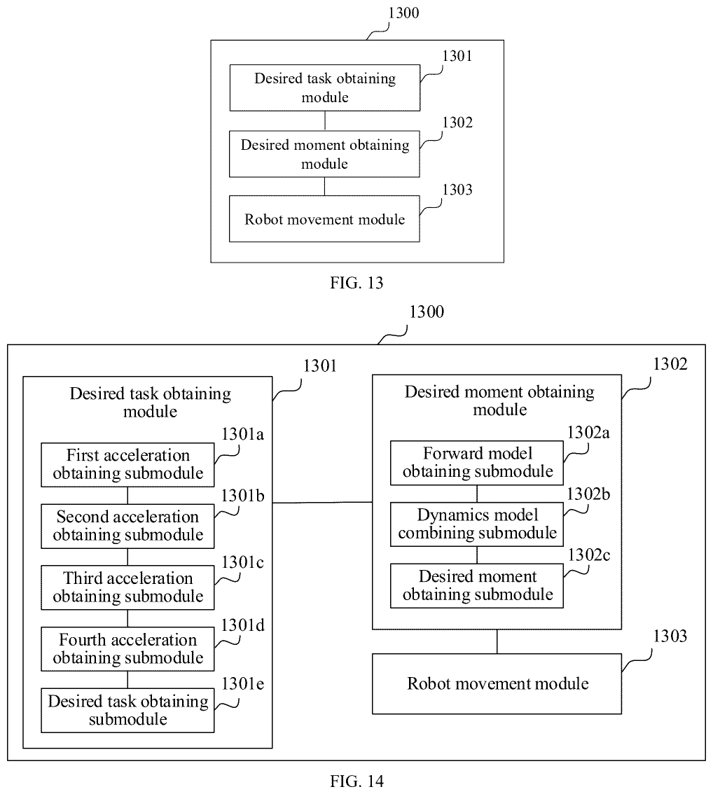

FIG. 13 is a block diagram of a control apparatus for a robot according to an embodiment of the present disclosure. The apparatus has a function of implementing the foregoing control method for a robot. The function may be implemented by hardware, or may be implemented by hardware executing corresponding software. The apparatus may be the computer device described above (for example, the wheel-legged robot), or may be arranged in the computer device. As shown in FIG. 13, the apparatus 1300 includes a desired task obtaining module 1301, a desired moment obtaining module 1302, and a robot movement module 1303.

The desired task obtaining module 1301 is configured to obtain a desired operation space task of the robot on a support plane, the desired operation space task including a desired acceleration of each part of the robot in an operation space of the robot, and the desired operation space task being configured for guiding the robot to alternately swing the first robotic leg set and the second robotic leg set to move on the support plane.

The desired moment obtaining module 1302 is configured to obtain a desired joint torque set corresponding to the desired operation space task based on the desired operation space task and a whole-body dynamics model of the robot, the desired joint torque set including desired joint torques configured for controlling all parts of the robot.

The robot movement module 1303 is configured to control, based on the desired joint torque set, the robot to move under guidance of the desired operation space task.

In some embodiments, as shown in FIG. 14, the desired moment obtaining module 1302 includes a forward model obtaining submodule 1302a, a dynamics model combining submodule 1302b, and a desired moment obtaining submodule 1302c.

The forward model obtaining submodule 1302a is configured to obtain a forward dynamics model of the robot, the forward dynamics model being configured to indicate a relationship between an acceleration of the robot in the operation space and a velocity and an acceleration of the robot in a joint space of the robot.

The dynamics model combining submodule 1302b is configured to combine the whole-body dynamics model and the forward dynamics model, to obtain a target dynamics equation, the acceleration of the robot in the joint space being used as an unknown variable of the target dynamics equation.

The desired moment obtaining submodule 1302c is configured to substitute the desired operation space task into the target dynamics equation, to obtain the desired joint torque set.

In some embodiments, the desired moment obtaining submodule 1302c is configured to:
replace the acceleration of the robot in the operation space in the target dynamics equation with the desired operation space task, to obtain an intermediate dynamics equation;
construct a physical joint constraint expression and a friction constraint expression of the robot, the physical joint constraint expression being configured for constraining each joint of the robot, and a contact force between the robot under a constraint of the friction constraint expression and the support plane satisfying a friction cone constraint; and
solve the intermediate dynamics equation under constraints of the physical joint constraint expression and the friction constraint expression of the robot, to obtain the desired joint torque set.

In some embodiments, the desired moment obtaining submodule 1302c is further configured to:
construct an objective function of the intermediate dynamics equation through a quadratic programming optimization method; and
obtain the desired joint torque set under an optimization objective of minimizing the objective function and under the constraints of the physical joint constraint expression and the friction constraint expression of the robot.

In some embodiments, during movement of the robot, a robotic leg set configured to swing is a swinging robotic leg set, and a robotic leg set configured to stance is a stance robotic leg set. As shown in FIG. 14, the desired task obtaining module 1301 includes a first acceleration obtaining submodule 1301a, a second acceleration obtaining submodule 1301b, a third acceleration obtaining submodule 1301c, a fourth acceleration obtaining submodule 1301d, and a desired task obtaining submodule 1301e.

The first acceleration obtaining submodule 1301a is configured to obtain a first desired acceleration of the swinging robotic leg set in the operation space based on a swinging reference movement trajectory corresponding to the swinging robotic leg set, the swinging reference movement trajectory being a movement trajectory of the swinging robotic leg set planned based on the support plane.

The second acceleration obtaining submodule 1301b is configured to obtain a second desired acceleration of the stance robotic leg set in the operation space based on a stance reference movement trajectory corresponding to the stance robotic leg set, the stance reference movement trajectory being a movement trajectory of the stance robotic leg set planned based on the support plane.

The third acceleration obtaining submodule 1301c is configured to obtain a third desired acceleration of a center of mass of the robot in the operation space based on a center-of-mass reference movement trajectory corresponding to the center of mass, the center-of-mass reference movement trajectory being a movement trajectory of the center of mass planned based on the support plane.

The fourth acceleration obtaining submodule 1301d is configured to obtain a fourth desired acceleration of a body of the robot in the operation space based on a posture reference change trajectory of the body, the posture reference change trajectory being a planned change trajectory of the body.

The desired task obtaining submodule 1301e is configured to obtain the desired operation space task based on the first desired acceleration, the second desired acceleration, the third desired acceleration, and the fourth desired acceleration.

In some embodiments, the robot stops moving after a plurality of control times. The first acceleration obtaining submodule 1301a is configured to:
obtain, for each control time, a reference position, a reference velocity, and a reference acceleration of the swinging robotic leg set at the control time based on the swinging reference movement trajectory; and
calculate the first desired acceleration at the control time through a PD feedback controller based on the reference position, the reference velocity, and the reference acceleration of the swinging robotic leg set at the control time, and an actual position and an actual velocity of the swinging robotic leg set at the control time.

In some embodiments, during stance of a stance robotic leg, no relative slide occurs between a foot of the stance robotic leg and the support plane, and a value of the second desired acceleration is constantly zero.

In some embodiments, the robot moves in a first direction. The third acceleration obtaining submodule 1301c is configured to:
obtain a third desired sub-acceleration of the center of mass in the first direction based on a reference movement sub-trajectory of the center-of-mass reference movement trajectory in the first direction;
obtain a third desired sub-acceleration of the center of mass in a second direction based on a reference movement sub-trajectory of the center-of-mass reference movement trajectory in the second direction, the second direction being perpendicular to the first direction; and
obtain the third desired acceleration based on the third desired sub-acceleration of the center of mass in the first direction and the third desired sub-acceleration of the center of mass in the second direction.

In some embodiments, the robot stops moving after a plurality of control times. The third acceleration obtaining submodule 1301c is further configured to:
construct an inverted pendulum dynamics equation of the robot by using a position of the center of mass, a velocity of the center of mass, a distance between the center of mass and a stance contact point in the first direction, and a derivative of the distance as state variables and using an acceleration of the center of mass relative to the stance contact point in the first direction as a control variable, the stance contact point being a contact point between the foot corresponding to the stance robotic leg set and the support plane;
calculate a feedback gain matrix of the inverted pendulum dynamics equation through an LQR;
obtain, for each control time, a reference position and a reference velocity of the center of mass and a reference distance and a reference velocity between the center of mass and the stance contact point in the first direction at the control time based on the reference movement sub-trajectory in the first direction; and
obtain a third desired sub-acceleration in the first direction at the control time based on the feedback gain matrix, and the reference position and the reference velocity of the center of mass and the reference distance and the reference velocity between the center of mass and the stance contact point in the first direction at the control time.

In some embodiments, the robot stops moving after a plurality of control times. The third acceleration obtaining submodule 1301c is further configured to:
obtain, for each control time, a reference position, a reference velocity, and a reference acceleration of the center of mass in the second direction at the control time based on the reference movement sub-trajectory in the second direction; and
calculate the third desired sub-acceleration in the second direction at the control time through the PD feedback controller based on the reference position, the reference velocity, and the reference acceleration of the center of mass in the second direction at the control time, and an actual position and an actual velocity of the center of mass in the second direction at the control time.

In some embodiments, the robot stops moving after a plurality of control times. The fourth acceleration obtaining submodule 1301d is configured to:
obtain, for each control time, a reference posture angle, a reference posture angular velocity, and a reference posture angular acceleration of the body at the control time based on the posture reference change trajectory; and
calculate the fourth desired acceleration at the control time through the PD feedback controller based on the reference posture angle, the reference posture angular velocity, and the reference posture angular acceleration of the body at the control time, and an actual posture angle and an actual posture angular velocity of the body at the control time.

In some embodiments, the body of the robot keeps vertical during movement of the robot, and a value of a reference posture angle, and a value of the reference posture angle, a value of the reference posture angular velocity, and a value of the reference posture angular acceleration corresponding to the body are all zero.

In some embodiments, the hip joints of the robot are coaxial.

In some embodiments, robotic legs in the first robotic leg set move synchronously, and robotic legs in the second robotic leg set move synchronously.

In conclusion, in the technical solutions provided in the embodiments of the present disclosure, for a robot having a first robotic leg set and a second robotic leg set, because rotation centers of hip joints corresponding to the robot are located in a same vertical plane, a desired operation space task may be planned, so that the robot quickly moves in a dynamic balance state (that is, a center of gravity of the robot may exceed a stance area of the robot) by causing one robotic leg set to perform stance and the other robotic leg set to swing. In addition, controlling the first robotic leg set and the second robotic leg set to swing alternately to control the robot to move can further improve the robot movement efficiency.

In addition, an accurate desired joint torque set corresponding to the desired operation space task can be obtained through the whole-body dynamics model of the robot based on the desired operation space task, so that the desired operation space task can be accurately implemented based on the desired joint torque set, thereby improving robot control accuracy.

When the apparatus provided in the foregoing embodiment implements the functions of the apparatus, only division of the foregoing functional modules is used as an example for description. In a practical application, the functions may be completed by different functional modules as required. To be specific, an internal structure of a device is divided into different functional modules to complete all or part of the functions described above. In addition, the apparatus provided in the foregoing embodiment belongs to the same idea as the method embodiment. For details of the specific implementation process thereof, refer to the method embodiment. Details are not described herein again.

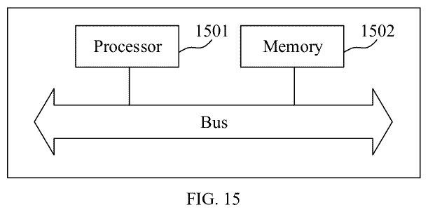

FIG. 15 is a simplified structural block diagram of a computer device according to an embodiment of the present disclosure. The computer device may be any electronic device having data computing, processing, and storage capabilities.

As shown in FIG. 15, the computer device may include a processor 1501 and a memory 1502. The processor 1501 may include but is not limited to a central processing unit (CPU), a graphics processing unit (GPU), and a field programmable gate array (FPGA). The memory 1502 may include a random access memory (RAM) and a read-only memory (ROM). The processor 1501 and the memory 1502 may be connected through a system bus.

In some embodiments, the memory 1502 has a computer program stored therein, the computer program being loaded and executed by the processor 1501 to implement the foregoing control method for a robot.

In some embodiments, a computer-readable storage medium is further provided, the storage medium having a computer program stored therein, the computer program, when executed by the computer device, implementing the foregoing control method for a robot.

In some embodiments, the computer-readable storage medium may include a ROM, a RAM, a solid state drive (SSD), an optical disc, or the like. The RAM may include a resistance random access memory (ReRAM) and a dynamic random access memory (DRAM).

In some embodiments, a computer program product is further provided, the computer program product including a computer program, the computer program being stored in a computer-readable storage medium. The processor of the computer device reads the computer program from the computer-readable storage medium, and the processor executes the computer program, so that the computer device performs the foregoing control method for a robot.

In the embodiments of the present disclosure, a prompt interface or a pop-up window may be displayed or voice prompt information may be outputted before and during collection of relevant data of a user. The prompt interface, the pop-up window, or the voice prompt information is configured for prompting the user that the relevant data is currently being collected, so that in the present disclosure, the relevant operation of obtaining the relevant data of the user is started only after a confirmation operation performed by the user on the prompt interface or the pop-up window is obtained. Otherwise (i.e., when the confirmation operation performed by the user on the prompt interface or the pop-up window is not obtained), the relevant operation of obtaining the relevant data of the user is ended, i.e., the relevant data of the user is not obtained. In other words, all user data collected in the present disclosure is processed in strict accordance with requirements of relevant national laws and regulations, and informed consent or individual consent of a subject of personal information is collected with consent and authorization of the user. Within the scope of authorization of laws and regulations and the subject of personal information, subsequent use and processing behaviors of data are carried out, and the collection, use, and processing of relevant user data need to comply with the relevant laws, regulations, and standards of relevant countries and regions. For example, all real environments and the like involved in the present disclosure are obtained under full authorization.

The term module (and other similar terms such as submodule, unit, subunit, etc.) in the present disclosure may refer to a software module, a hardware module, or a combination thereof. A software module (e.g., computer program) may be developed using a computer programming language. A hardware module may be implemented using processing circuitry and/or memory. Each module can be implemented using one or more processors (or processors and memory). Likewise, a processor (or processors and memory) can be used to implement one or more modules. Moreover, each module can be part of an overall module that includes the functionalities of the module.

“Plurality of” mentioned in the specification means two or more. The term “and/or” is an association relationship for describing associated objects and represents that three relationships may exist. For example, A and/or B may represent the following three cases: only A exists, both A and B exist, and only B exists. The character “/” generally indicates an “or” relationship between a preceding associated object and a succeeding associated object. In addition, the operation numbers described in this specification merely exemplarily show a possible execution sequence of the operations. In some other embodiments, the foregoing operations may not be performed based on the number sequence. For example, two operations with different numbers may be performed simultaneously, or two operations with different numbers may be performed based on a sequence contrary to the sequence shown in the figure. This is not limited in the embodiments of the present disclosure.

The technical solutions provided in the embodiments of the present disclosure include the following beneficial effects.

For a robot having a first robotic leg set and a second robotic leg set, because centers of rotation of hip joints corresponding to the first robotic leg set and the second robotic leg set are located on a same vertical plane, one robotic leg set may be caused to stand, and the other robotic leg set may be caused to swing through planning of a desired operation space task, so that the robot quickly moves in a dynamic balanced state (to be specific, a center of gravity of the robot may exceed a stance area or a support area of the robot), thereby improving robot movement efficiency. In addition, controlling the first robotic leg set and the second robotic leg set to swing alternately to control the robot to move can further improve the robot movement efficiency.

In addition, an accurate desired joint torque set corresponding to the desired operation space task can be obtained through the whole-body dynamics model of the robot based on the desired operation space task, so that the desired operation space task can be accurately implemented based on the desired joint torque set, thereby improving robot control accuracy.

The foregoing descriptions are merely exemplary embodiments of the present disclosure, and are not intended to limit the present disclosure. Any modification, equivalent replacement, or improvement made within the spirit and principle of the present disclosure falls within the protection scope of the present disclosure.

What is claimed is:

1. A control method for a robot, performed by a computer device, the robot comprising a body, and a first robotic leg set and a second robotic leg set connected to the body through hip joints, at least one of the first robotic leg set and the second robotic leg set comprising at least two robotic legs, and a rotation center of a hip joint corresponding to the first robotic leg set and a rotation center of a hip joint corresponding to the second robotic leg set being located on a same vertical plane, and the method comprising:
obtaining a desired operation space task of the robot on a support plane, the desired operation space task comprising a desired acceleration of a part of the robot in an operation space of the robot, and the desired operation space task being configured for guiding the robot to alternately swing the first robotic leg set and the second robotic leg set to move on the support plane;
obtaining, according to the desired operation space task and a whole-body dynamics model of the robot, a desired joint torque set corresponding to the desired operation space task, the desired joint torque set comprising desired joint torques configured for controlling all parts of the robot; and
controlling, based on the desired joint torque set, the robot to move under guidance of the desired operation space task.

2. The method according to claim 1, wherein obtaining the desired joint torque set corresponding to the desired operation space task comprises:
obtaining a forward dynamics model of the robot, the forward dynamics model being configured to indicate a relationship between an acceleration of the robot in the operation space and a velocity and an acceleration of the robot in a joint space of the robot;
combining the whole-body dynamics model and the forward dynamics model, to obtain a target dynamics equation, the acceleration of the robot in the joint space being used as an unknown variable of the target dynamics equation; and
substituting the desired operation space task into the target dynamics equation, to obtain the desired joint torque set.

3. The method according to claim 2, wherein substituting the desired operation space task into the target dynamics equation, to obtain the desired joint torque set comprises:
replacing the acceleration of the robot in the operation space in the target dynamics equation with the desired operation space task, to obtain an intermediate dynamics equation;
constructing a physical joint constraint expression and a friction constraint expression of the robot, the physical joint constraint expression being configured for constraining each joint of the robot, and a contact force between the robot under a constraint of the friction constraint expression and the support plane satisfying a friction cone constraint; and
solving the intermediate dynamics equation under constraints of the physical joint constraint expression and the friction constraint expression of the robot, to obtain the desired joint torque set.

4. The method according to claim 3, wherein solving the intermediate dynamics equation under constraints of the physical joint constraint expression and the friction constraint expression of the robot, to obtain the desired joint torque set comprises:
constructing an objective function of the intermediate dynamics equation through a quadratic programming optimization method; and
obtaining the desired joint torque set under an optimization objective of minimizing the objective function and under the constraints of the physical joint constraint expression and the friction constraint expression of the robot.

5. The method according to claim 1, wherein during movement of the robot, a robotic leg set configured to swing is a swinging robotic leg set, and a robotic leg set configured for stance is a stance robotic leg set; and obtaining the desired operation space task of the robot on the support plane comprises:
obtaining a first desired acceleration of the swinging robotic leg set in the operation space based on a swinging reference movement trajectory corresponding to the swinging robotic leg set, the swinging reference movement trajectory being obtained through movement trajectory planning for the swinging robotic leg set based on the support plane;
obtaining a second desired acceleration of the stance robotic leg set in the operation space based on a stance reference movement trajectory corresponding to the stance robotic leg set, the stance reference movement trajectory being obtained through movement trajectory planning for the stance robotic leg set based on the support plane;
obtaining a third desired acceleration of a center of mass of the robot in the operation space based on a center-of-mass reference movement trajectory corresponding to the center of mass, the center-of-mass reference movement trajectory being obtained through movement trajectory planning for the center of mass based on the support plane;
obtaining a fourth desired acceleration of a body of the robot in the operation space based on a posture reference change trajectory of the body, the posture reference change trajectory being obtained through change trajectory planning for the body; and
obtaining the desired operation space task based on the first desired acceleration, the second desired acceleration, the third desired acceleration, and the fourth desired acceleration.

6. The method according to claim 5, wherein the robot stops moving after a plurality of control times; and obtaining the first desired acceleration of the swinging robotic leg set in the operation space comprises:
obtaining, for a control time of the plurality of control times, a reference position, a reference velocity, and a reference acceleration of the swinging robotic leg set at the control time based on the swinging reference movement trajectory; and
calculating the first desired acceleration at the control time through a proportional derivative (PD) feedback controller based on the reference position, the reference velocity, and the reference acceleration of the swinging robotic leg set at the control time, and an actual position and an actual velocity of the swinging robotic leg set at the control time.

7. The method according to claim 5, wherein during stance of the stance robotic leg, no relative slide occurs between a foot of the stance robotic leg and the support plane, and a value of the second desired acceleration is constantly zero.

8. The method according to any one of claim 5, wherein the robot moves in a first direction; and obtaining the third desired acceleration of the center of mass of the robot in the operation space comprises:
obtaining a third desired sub-acceleration of the center of mass in the first direction based on a reference movement sub-trajectory of the center-of-mass reference movement trajectory in the first direction;
obtaining a third desired sub-acceleration of the center of mass in a second direction based on a reference movement sub-trajectory of the center-of-mass reference movement trajectory in the second direction, the second direction being perpendicular to the first direction; and
obtaining the third desired acceleration based on the third desired sub-acceleration of the center of mass in the first direction and the third desired sub-acceleration of the center of mass in the second direction.

9. The method according to claim 8, wherein the robot stops moving after a plurality of control times; and obtaining the third desired sub-acceleration of the center of mass in the first direction comprises:
constructing an inverted pendulum dynamics equation of the robot by using a position of the center of mass, a velocity of the center of mass, a distance between the center of mass and a stance contact point in the first direction, and a derivative of the distance as state variables and using an acceleration of the center of mass relative to the stance contact point in the first direction as a control variable, the stance contact point being a contact point between the foot corresponding to the stance robotic leg set and the support plane;
calculating a feedback gain matrix of the inverted pendulum dynamics equation through a linear quadratic regulator (LQR);
obtaining, for a control time of the plurality of control times, a reference position and a reference velocity of the center of mass and a reference distance and a reference velocity between the center of mass and the stance contact point in the first direction at the control time based on the reference movement sub-trajectory in the first direction; and
obtaining a third desired sub-acceleration in the first direction at the control time based on the feedback gain matrix, and the reference position and the reference velocity of the center of mass and the reference distance and the reference velocity between the center of mass and the stance contact point in the first direction at the control time.

10. The method according to claim 8, wherein the robot stops moving after a plurality of control times; and obtaining the third desired sub-acceleration of the center of mass in the second direction comprises:
obtaining, for a control time of the plurality of control times, a reference position, a reference velocity, and a reference acceleration of the center of mass in the second direction at the control time based on the reference movement sub-trajectory in the second direction; and
calculating the third desired sub-acceleration in the second direction at the control time through the PD feedback controller based on the reference position, the reference velocity, and the reference acceleration of the center of mass in the second direction at the control time, and an actual position and an actual velocity of the center of mass in the second direction at the control time.

11. The method according to any one of claims 5 to 10, wherein the robot stops moving after a plurality of control times; and obtaining the fourth desired acceleration of the body of the robot in the operation space comprises:
obtaining, for a control time of the plurality of control times, a reference posture angle, a reference posture angular velocity, and a reference posture angular acceleration of the body at the control time based on the posture reference change trajectory; and
calculating the fourth desired acceleration at the control time through the PD feedback controller based on the reference posture angle, the reference posture angular velocity, and the reference posture angular acceleration of the body at the control time, and an actual posture angle and an actual posture angular velocity of the body at the control time.

12. The method according to claim 11, wherein the body of the robot maintains vertical during movement of the robot, and a value of a reference posture angle, and a value of the reference posture angle, a value of the reference posture angular velocity, and a value of the reference posture angular acceleration corresponding to the body are all zero.

13. The method according to claim 1, wherein hip joints of the robot are coaxial.

14. The method according to claim 1, wherein robotic legs in the first robotic leg set move synchronously, and robotic legs in the second robotic leg set move synchronously.

15. A computer device comprising one or more processors and a memory containing a computer program that, when being executed, causes the one or more processors to perform:
obtaining a desired operation space task of a robot on a support plane, the desired operation space task comprising a desired acceleration of a part of the robot in an operation space of the robot, and the desired operation space task being configured for guiding the robot to alternately swing a first robotic leg set and a second robotic leg set to move on the support plane;
obtaining, according to the desired operation space task and a whole-body dynamics model of the robot, a desired joint torque set corresponding to the desired operation space task, the desired joint torque set comprising desired joint torques configured for controlling all parts of the robot; and
controlling, based on the desired joint torque set, the robot to move under guidance of the desired operation space task.

16. The device according to claim 15, wherein the one or more processors are further configured to perform:
obtaining a forward dynamics model of the robot, the forward dynamics model being configured to indicate a relationship between an acceleration of the robot in the operation space and a velocity and an acceleration of the robot in a joint space of the robot;
combining the whole-body dynamics model and the forward dynamics model, to obtain a target dynamics equation, the acceleration of the robot in the joint space being used as an unknown variable of the target dynamics equation; and
substituting the desired operation space task into the target dynamics equation, to obtain the desired joint torque set.

17. The device according to claim 16, wherein the one or more processors are further configured to perform:
replacing the acceleration of the robot in the operation space in the target dynamics equation with the desired operation space task, to obtain an intermediate dynamics equation;
constructing a physical joint constraint expression and a friction constraint expression of the robot, the physical joint constraint expression being configured for constraining each joint of the robot, and a contact force between the robot under a constraint of the friction constraint expression and the support plane satisfying a friction cone constraint; and
solving the intermediate dynamics equation under constraints of the physical joint constraint expression and the friction constraint expression of the robot, to obtain the desired joint torque set.

18. The device according to claim 17, wherein the one or more processors are further configured to perform:
constructing an objective function of the intermediate dynamics equation through a quadratic programming optimization method; and
obtaining the desired joint torque set under an optimization objective of minimizing the objective function and under the constraints of the physical joint constraint expression and the friction constraint expression of the robot.

19. The device according to claim 15, wherein during movement of the robot, a robotic leg set configured to swing is a swinging robotic leg set, and a robotic leg set configured for stance is a stance robotic leg set; and the one or more processors are further configured to perform:
obtaining a first desired acceleration of the swinging robotic leg set in the operation space based on a swinging reference movement trajectory corresponding to the swinging robotic leg set, the swinging reference movement trajectory being obtained through movement trajectory planning for the swinging robotic leg set based on the support plane;
obtaining a second desired acceleration of the stance robotic leg set in the operation space based on a stance reference movement trajectory corresponding to the stance robotic leg set, the stance reference movement trajectory being obtained through movement trajectory planning for the stance robotic leg set based on the support plane;
obtaining a third desired acceleration of a center of mass of the robot in the operation space based on a center-of-mass reference movement trajectory corresponding to the center of mass, the center-of-mass reference movement trajectory being obtained through movement trajectory planning for the center of mass based on the support plane;
obtaining a fourth desired acceleration of a body of the robot in the operation space based on a posture reference change trajectory of the body, the posture reference change trajectory being obtained through change trajectory planning for the body; and
obtaining the desired operation space task based on the first desired acceleration, the second desired acceleration, the third desired acceleration, and the fourth desired acceleration.

20. A non-transitory computer readable storage medium containing a computer program that, when being executed, causes at least one processor to perform:
obtaining a desired operation space task of a robot on a support plane, the desired operation space task comprising a desired acceleration of a part of the robot in an operation space of the robot, and the desired operation space task being configured for guiding the robot to alternately swing a first robotic leg set and a second robotic leg set to move on the support plane;
obtaining, according to the desired operation space task and a whole-body dynamics model of the robot, a desired joint torque set corresponding to the desired operation space task, the desired joint torque set comprising desired joint torques configured for controlling all parts of the robot; and
controlling, based on the desired joint torque set, the robot to move under guidance of the desired operation space task.
